(19) United States
(12) Patent Application Publication
(10) Pub. No.: US 2023/0176005 A1
(43) Pub. Date: Jun. 8, 2023

(54) SENSOR CONTROL UNIT

(71) Applicant: DENSO CORPORATION, Kariya-city (JP)

(72) Inventors: Go MIYAGAWA, Kariya-city (JP); Kazuki YAGI, Kariya-city (JP); Kei SUGIURA, Kariya-city (JP)

(21) Appl. No.: 18/161,449

(22) Filed: Jan. 30, 2023

Related U.S. Application Data
(63) Continuation of application No. PCT/JP2021/027433, filed on Jul. 23, 2021.

(30) Foreign Application Priority Data
Jul. 31, 2020 (JP) 2020-130276

(51) Int. Cl. G01N 27/406; G01N 27/409; G01N 27/419

(52) U.S. Cl. CPC G01N 27/4067; G01N 27/409; G01N 27/419; G01N 27/41

(57) ABSTRACT

The sensor control unit is used for a gas sensor disposed in an exhaust pipe in an engine as an internal combustion engine of a vehicle. The gas sensor includes a sensor cell having an exhaust gas electrode, an atmosphere side electrode and a solid electrolyte, and a heater that heats the sensor cell. The sensor control unit includes a heater control unit that controls a heater to heat a sensor cell. The heater control unit heats the sensor cell to be at an operation control temperature during the combustion operation of the engine and heats the sensor cell to be at an operation stop control temperature which is higher than the operation control temperature.

### CROSS-REFERENCE OF RELATED APPLICATIONS

This application is a continuation application of International Application No. PCT/JP2021/027433 filed on Jul. 23, 2021, which designated the U.S. and claims priority to Japanese Patent Application No. 2020-130276, filed Jul. 31, 2020, the contents of both of these are incorporated herein by reference.

### BACKGROUND

### Technical Field

The present disclosure relates to a sensor control unit.

### Description of the Related Art

A gas sensor is disposed in an exhaust pipe of an engine as an internal combustion engine. With an exhaust gas as a gas to be detected, the gas sensor acquires an air fuel ratio of an engine, an oxygen concentration of the exhaust gas and the like. The gas sensor utilizes a sensor element provided with a solid electrolyte having an oxide ion conductivity and a pair of electrodes provided on a surface of the solid electrolyte. One electrode is used for an exhaust gas electrode exposed to an exhaust gas and the other electrode is used for an atmosphere side electrode as an opposite electrode allowing oxide ion to be conducted to the exhaust gas electrode.

### SUMMARY

One aspect of the present disclosure is a sensor control unit used for a gas sensor disposed in an exhaust pipe in an internal combustion engine of a vehicle, the gas sensor having a sensor cell provided with an exhaust gas electrode exposed to an exhaust gas, an atmosphere side electrode exposed to atmospheric air and a solid electrolyte interposed therebetween on which the exhaust gas electrode and the atmosphere side electrode are disposed facing each other, and a heater that heats the sensor cell. The sensor control unit includes: a heater control unit that controls the heater for heating the sensor cell. The heater control unit heats, during a combustion operation of the internal combustion engine, the sensor cell to be at an operation control temperature, and heats, during a combustion stop period of the internal combustion engine, the sensor cell to be at an operation stop control temperature which is higher than the operation control temperature.

Note that reference numbers in brackets assigned to respective elements in the embodiments of the present disclosure indicate an example of correspondence relationship between the elements and specific components in embodiments. Hence, the present disclosure is not limited to constituents labeled by these reference numbers.

### BRIEF DESCRIPTION OF THE DRAWINGS

The objects, features, and advantages of the present disclosure will be more clarified by the following detailed descriptions with reference to the accompanying drawings. The drawings of the present disclosure are as follows:

FIG. 1 is an explanatory diagram showing a gas sensor according to a first embodiment in a cross-sectional view;

FIG. 2 is an explanatory diagram showing a sensor element according to the first embodiment in a cross-sectional view;

FIG. 3 is an explanatory diagram showing the sensor element according to the first embodiment in a cross-sectional view sectioned at a line shown in FIG. 2;

FIG. 4 is an explanatory diagram showing the sensor element according to the first embodiment in a cross-sectional view sectioned at a line IV-IV shown in FIG. 2;

FIG. 5 is an explanatory diagram showing the gas sensor and a sensor control unit according to the first embodiment;

FIG. 6 is an explanatory diagram showing an electrical configuration of the gas sensor and the sensor control unit according to the first embodiment;

FIG. 7 is a graph showing a relationship between the air fuel ratio and the output current;

FIG. 8 is an explanatory diagram showing a poisoning film formed on the atmosphere side electrode according to the present embodiment;

FIG. 9 is a flowchart showing a control method executed by the sensor control unit according to the present embodiment;

FIG. 10 is a timing diagram in which (a) shows a change in a vehicle speed, (b) shows a change in a siloxane density in an engine compartment, (c) shows a change in an excess air ratio of an engine, and (d) shows a change in a heating temperature of a sensor cell heated by a heater control unit;

FIG. 11 is an explanatory diagram showing an electrical configuration of a gas sensor and a sensor control unit according to a second embodiment;

FIG. 12 is a timing diagram in which (a) shows a change in a vehicle speed, (b) shows a change in an excess air ratio of an engine, and (c) shows a change in a voltage applied to a sensor cell by a voltage application unit according to the second embodiment;

FIG. 13 is a graph showing a relationship between the voltage and current in a sensor cell according to the second embodiment;

FIG. 14 is a timing diagram in which (a) shows a change in a heating temperature of the sensor cell heated by a heater control unit, (b) shows a change in a voltage applied to the sensor cell by the voltage application unit according to the present embodiment, (c) shows a change in an output current generated in the sensor cell, and (d) shows a change in an electrical resistance of the sensor cell;

FIG. 15 is a flowchart showing a control method executed by the sensor control unit according to the second embodiment;

FIG. 16 is a timing diagram in which (a) shows a change in a vehicle speed, (b) shows a change in a heating temperature of a sensor cell heated by a heater control unit, (c) shows a change in a voltage applied to the sensor cell by a voltage application unit according to a third embodiment;

FIG. 17 is a graph showing a relationship between a temperate and a reduction potential of oxygen-deficient silica according to the third embodiment;

FIG. 18 is a flowchart showing a control method executed by the sensor control unit according to the third embodiment;

FIG. 19 is a flowchart showing a control method executed by a sensor control unit according to a fourth embodiment;

FIG. 20 is an explanatory diagram showing an electrical configuration of a gas sensor and a sensor control unit according to a fifth embodiment; and

FIG. 21 is a flowchart showing a control method of a sensor control unit according to a fifth embodiment.

### DETAILED DESCRIPTION OF THE PREFERRED EMBODIMENTS

A gas sensor is disposed in an exhaust pipe of an engine as an internal combustion engine. With an exhaust gas as a gas to be detected, the gas sensor acquires an air fuel ratio of an engine, an oxygen concentration of the exhaust gas and the like. The gas sensor utilizes a sensor element provided with a solid electrolyte having an oxide ion conductivity and a pair of electrodes provided on a surface of the solid electrolyte. One electrode is used for an exhaust gas electrode exposed to an exhaust gas and the other electrode is used for an atmosphere side electrode as an opposite electrode allowing oxide ion to be conducted to the exhaust gas electrode.

The atmospheric air which is present in an engine compartment or the like is introduced to the atmosphere side electrode in the sensor element of the gas sensor. Since the atmospheric air in the engine compartment contains siloxane gas as a gaseous compound containing silicon and oxygen, the siloxane gas as a poisoning substance may cause poisoning on the atmosphere side electrode, thereby degrading the atmosphere side electrode.

For example, according to the sensor control unit of patent literature JP-A-2017-75794, the sensor control unit is configured to perform, in order to suppress the atmosphere side electrode from being poisoned and degradation in the case where the atmosphere side electrode is in a poisoning environment, pumping of oxygen from the exhaust gas to the atmosphere side electrode. With this configuration, an atmosphere duct, where the atmosphere electrodes are provided, is filled with oxygen present in the exhaust pipe via the exhaust gas electrode and not with the oxygen present in the engine compartment.

According to the sensor control unit of the above-described patent literature, in order to suppress the atmosphere side electrode from being poisoned and degraded, only oxygen pumping is performed from the exhaust gas electrode to the atmosphere side electrode by applying a voltage between the exhaust gas electrode and the atmosphere side electrode. However, in order to suppress the atmosphere side electrode from being poisoned and degraded more effectively, further improvement is required in addition to the oxygen pumping.

With reference to the drawings, preferred embodiments according to the above-described sensor control unit will be described.

### First Embodiment

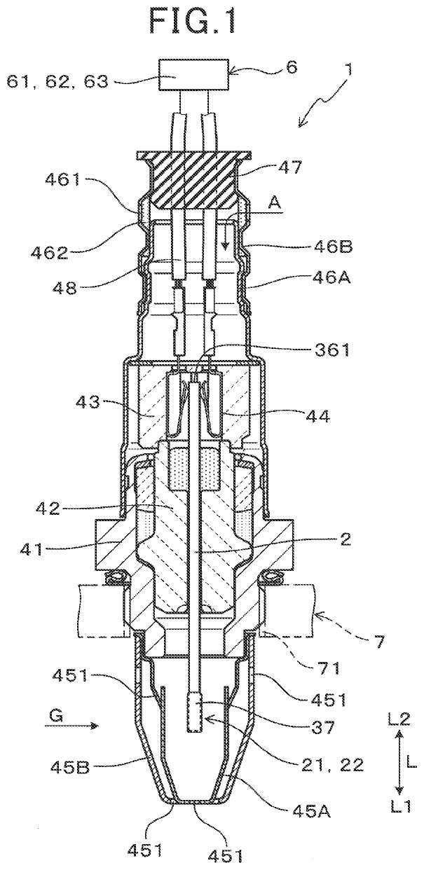

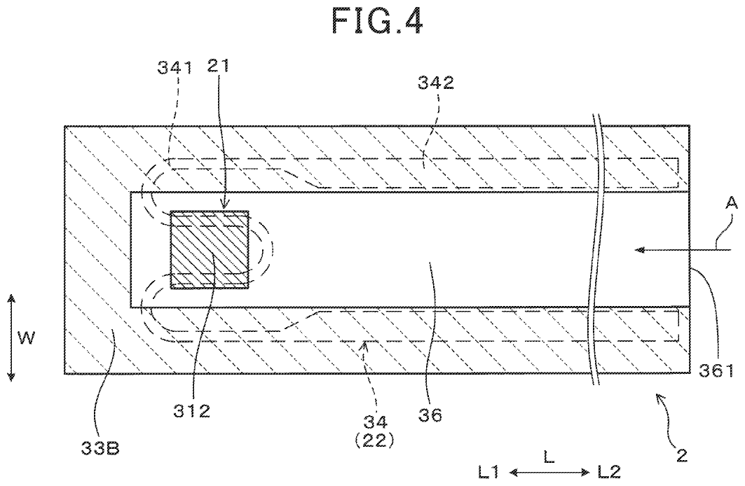

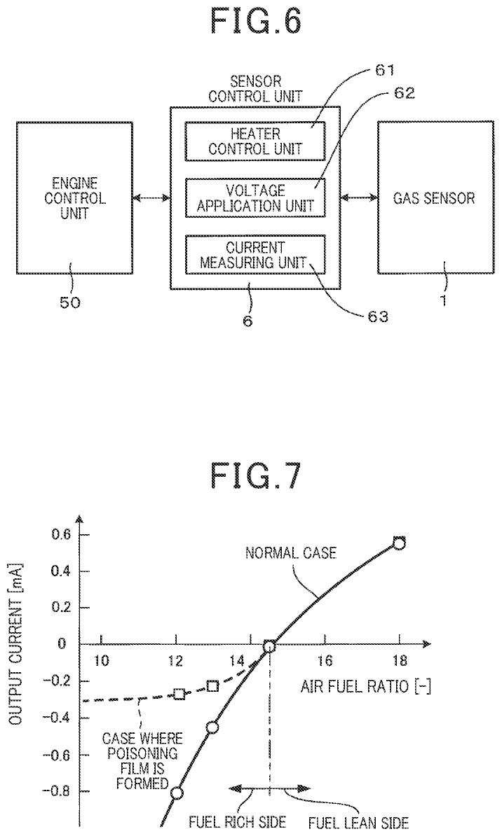

As shown in FIGS. 1 to 6, a sensor control unit 6 according to the present embodiment is used for a gas sensor 1 disposed in an exhaust pipe 7 of an engine 5 as an internal combustion engine of a vehicle. The gas sensor 1 includes a sensor cell 21, a heater 22 for hearting the sensor cell 21. The sensor cell 21 is provided with an exhaust gas electrode 311 exposed to an exhaust gas G, an atmosphere side electrode 312 exposed to an atmospheric air A, and a solid electrolyte 31 on which the exhaust gas electrode 311 and the atmosphere side electrode 312 facing each other.

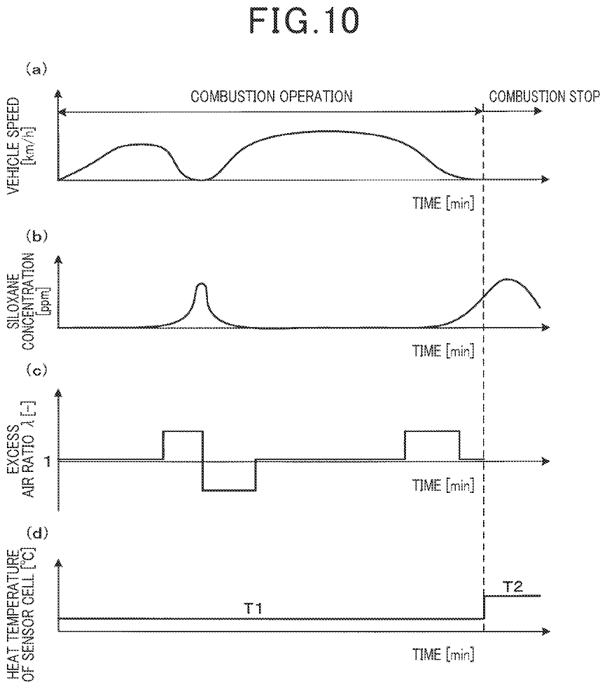

The sensor control unit 6 includes a heater control unit 61 that controls the heater 22 for heating the sensor cell 21. As shown in FIG. 10, the heater control unit 61 is configured to control the heater 22 such that the sensor cell 21 is heated by the heater 22 at an operation control temperature T1 when the engine 5 is in a combustion operation, and heated by the heater 22 at an operation stop control temperature T2 higher than the operation control temperature T1 when the engine 5 is in a combustion stopped state.

Firstly, a gas sensor 1 of the present embodiment will be described in detail.

(Gas Sensor 1)

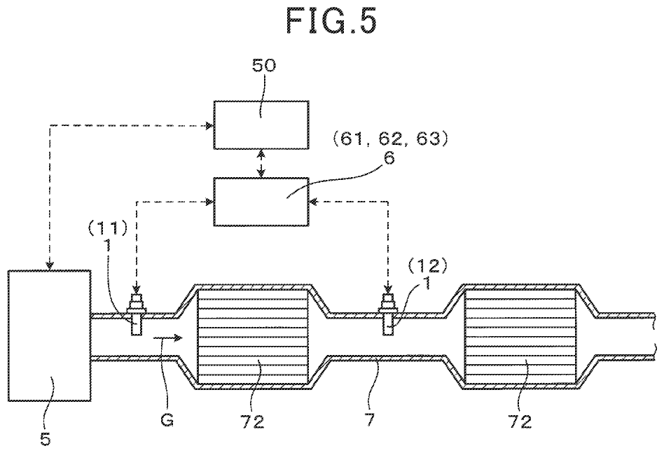

As shown in FIGS. 1 and 5, the gas sensor 1 is disposed in a mount hole 71 of the exhaust pipe 8 of the engine 5 of the vehicle. The gas sensor 1 is used for detecting an oxygen concentration or the like in a gas to be detected which is the exhaust gas G flowing through the exhaust pipe 7. The gas sensor 1 can be utilized as an air fuel ratio sensor (A/F sensor) that acquires the air fuel ratio of the engine 5 based on the oxygen concentration and unburned gas concentration or the like in the exhaust gas G. The A/F sensor is capable of quantitatively detecting the air fuel ratio continuously between a fuel rich state where a ratio of fuel to air is larger than the theoretical air fuel ratio and a fuel lean state where a ratio of fuel to air is smaller than the theoretical air fuel ratio. Moreover, the gas sensor 1 can be used as various sensors for detecting oxygen concentration other than the air fuel ratio sensor.

As shown in FIG. 5, a catalyst 72 is disposed in the exhaust pipe 7 to purify poisoning substances in the exhaust gas G. The gas sensor 1 can be disposed at an upstream side or a downstream side of the catalyst 72 in a direction where the exhaust gas G flows in the exhaust pipe 7. Also, the gas sensor 1 may be disposed in an inlet side pipe of a supercharger that increases the air density of the air suctioned by the engine 5 by using the exhaust gas G. The pipe to which the gas sensor 1 is mounted may utilize a pipe in an exhaust gas recirculation mechanism that recirculates a part of the exhaust gas G exhausted from the exhaust pipe 7 from the engine 5 into the inlet pipe of the engine 5.

As shown in FIG. 5, the engine 5 according to the present embodiment is a gasoline engine and a three-way catalyst 72 as the catalyst 72 is disposed in the exhaust pipe 7. The gas sensor 1 according to the present embodiment constitutes an air fuel ratio sensor 11 disposed in the exhaust pipe 7, being positioned in an upstream side in a gas flow of the exhaust gas G compared to the position of the three-way catalyst 72. In the air fuel ratio sensor 11, a laminate type sensor element 2 having plate-shaped solid electrolyte (described later) can be utilized.

Further, the gas sensor 1 may constitute an oxygen sensor 12 disposed being positioned in a downstream side of a gas flow of the exhaust gas G compared to the position of the three-way catalyst 72. According to the present embodiment, a plurality of the three-way catalysts 72 are arranged as a multi-staged catalyst each separately positioned relative to the gas flow. The oxygen sensor 12 is disposed adjacently to a downstream side of the three-way catalyst 72 which is positioned at the most upstream side in the exhaust pipe 7. For the oxygen sensor 12, a cup type sensor element having a cup-shaped solid electrolyte 31 can be utilized. The oxygen sensor is able to determine whether the air fuel ratio of the engine 5 estimated with the exhaust gas G is in the fuel rich side or the fuel lean side relative to the theoretical air fuel ratio.

Although, illustration is omitted, the engine 5 may be a diesel engine and a reduction catalyst that reduces NOx (nitrogen oxides) may be disposed in the exhaust pipe 7 together with or instead of the three-way catalyst 72. The reduction catalyst includes a storage reduction type nitrogen oxide catalyst (LNT), a selective reduction catalyst (SCR) and the like. The storage reduction type nitrogen oxide catalyst causes carbon monoxide, hydrocarbons and the like, which increase in the exhaust gas G when a relatively large amount of fuel is injected into the engine, to react with stored NOx, thereby reducing them to nitrogen. The selective reduction catalyst reduces NOx to nitrogen using ammonia.

The gas sensor 1 may be a NOx sensor disposed in the exhaust pipe 7, being positioned in an upstream side or a downstream side in the gas flow of the exhaust gas G compared to the position of the reduction catalyst. According to the sensor element 2 that constitutes the NOx sensor, a pump electrode is disposed in a gas chamber 35 (described later), being positioned in an upstream side of the gas flow of the exhaust gas G compared to the position of the exhaust gas electrode 311. The pump electrode is applied with a voltage for pumping oxygen to the atmosphere side electrode 312. The atmosphere side electrode 312 is formed at a position facing the detection electrode and the pump electrode via the solid electrolyte 31. In the exhaust pipe 7, a diesel oxidation catalyst (DOC) that oxidizes soluble organic component (SOF) of particulate matter, carbon monoxide, hydrocarbons contained in the exhaust gas G may be provided.

(Sensor Element 2)

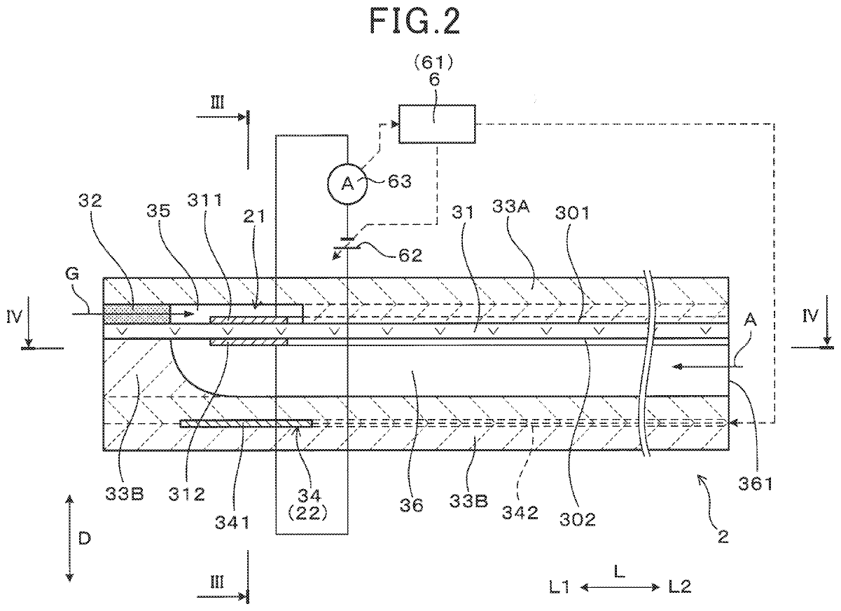

As shown in FIGS. 2 to 4, the sensor element 2 is configured as a laminate type sensor in which respective insulators 33A and 33B and a heating element 34 are laminated on the plate-shaped solid electrolyte 31 on which the exhaust gas electrode 311 and the atmosphere side electrode 312 are provided. In the sensor element 2, a sensor cell 21 is formed as a portion composed of the exhaust electrode 31, the atmosphere side electrode 312 and a part of solid electrolyte 31 positioned between the exhaust gas electrode 311 and the atmosphere side electrode 312. The sensor cell 21 is formed at a tip end side portion in the sensor element 2 having an elongated shape.

According to the present embodiment, a direction where the sensor element 2 extends longitudinally is defined as a longitudinal direction L. Also, a direction orthogonal to the longitudinal direction L, where the respective insulators 33A, 33b and heating element 34 are laminated, that is, a direction where the sensor cell 21 and the heater 22 are laminated is defined as a lamination direction D. Further, a direction orthogonal to the longitudinal direction L and the lamination direction D is defined as a width direction W. In the longitudinal direction L of the sensor element 2, a portion exposed to the exhaust gas G is defined as a tip end side L1 and a portion opposite to the tip end side L1 is defined as base end side L2.

(Sensor Cell 21)

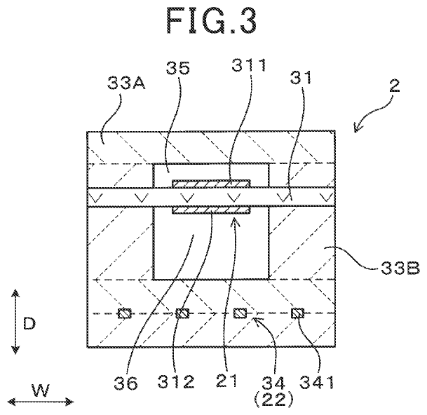

As shown in FIGS. 2 and 3, the solid electrolyte 31 that constitutes the sensor cell 21 has conductivity to oxide ion (O²⁻) at a predetermined activation temperature. The solid electrolyte 31 has a first surface 301 on which the exhaust gas electrode 311 exposed to the exhaust gas G is provided and a second surface 302 on which the atmosphere side electrode 312 exposed to the atmospheric air A. In a portion of the tip end side L1 exposed to the exhaust gas G with respect to the longitudinal direction L of the sensor element 2, the exhaust gas electrode 311 and the atmosphere side electrode 312 are arranged at a position where exhaust gas electrode 311 and the atmosphere side electrode 312 are overlapped in the lamination direction D via the solid electrolyte 31. The first insulator 33A is laminated on the first surface 301 of the solid electrolyte 31 and the second insulator 33B is laminated on the second surface 302 of the solid electrolyte 31.

The solid electrolyte 31 is composed of zirconia-based oxide in which the zirconia is a main component (contained 50 mass % or more), and composed of a stabilized zirconia or a partially stabilized zirconia where zirconia is partly substituted by a metallic element of rare earth group or an alkaline earth metal. A part of zirconia that constitutes the solid electrolyte 31 may be substituted by yttria, scandia or calcia.

The exhaust gas electrode 311 and the atmosphere side electrode 312 that constitute the sensor cell 21 contains platinum as a noble metal showing a catalytic activity to oxygen, and a zirconia based oxide as a common material of the solid electrolyte 31. In the case where pasted electrode material is printed (coated) on the solid electrolyte 31 and the solid electrolyte 31 and the electrode material are fired, the common material functions to maintain a bond strength between the exhaust electrode 311 and the atmosphere side electrode 312, and the solid electrolyte 31.

(Gas Chamber 35)

As shown in FIGS. 2 and 3, a gas chamber 35 is adjacently formed on the first surface 301 of the solid electrolyte 31 being surrounded by the first insulator 33A and the solid electrolyte 31. In a tip end side portion of the first insulator 33A positioned in the tip end side L1 with respect to the longitudinal direction L thereof, the gas chamber 35 is formed at a position accommodating the exhaust gas electrode 311. The gas chamber 35 is formed as a space section closed by the first insulator 33A and a diffusion resistance section 32 (gas introducing section). The exhaust gas G flowing through the exhaust pipe 7 passes through the diffusion resistance section 32 and is introduced into the gas chamber 35.

(Diffusion Resistance Section 32)

As shown in FIG. 2, the diffusion resistance section 32 according to the present embodiment is provided adjacently to a portion of the gas chamber 35 in the tip end side L1 with respect to the longitudinal direction. In other words, the diffusion resistance section 32 is formed at a tip end surface of the sensor element 2 in the longitudinal direction L. The diffusion resistance section 32 is formed in the first insulator 33A such that a porous material of a metal oxide such as aluminum oxide is filled into an inlet hole which is opened and positioned adjacently to the gas chamber 35 in the tip end side L1 with respect to the longitudinal direction L. The diffusion velocity (flow rate) of the exhaust gas G introduced into the gas chamber 35 is determined by limiting the velocity of the exhaust gas G passing through pores of the porous material in the diffusion resistance section 32.

The diffusion resistance section 32 may be formed adjacently to both sides in the width direction W of the gas chamber. In this case, the diffusion resistance section 32 is disposed in the inlet hole opened adjacently to both sides of the width direction W of the gas chamber 35. Note that the introducing hole 32 may be formed using a pin hole as a small through hole communicating with the gas chamber 35 instead of forming the porous material.

(Atmospheric Duct)

As shown in FIGS. 2 to 4, the atmospheric duct 36 surrounded by the second insulator 33B and the solid electrolyte 31 is formed on the second surface 302 of the solid electrolyte 31. The atmospheric duct 36 is formed from a portion of the second insulator 33B accommodating the atmosphere side electrode 312 in the longitudinal direction L to a base end portion of the sensor element 2 in the longitudinal direction L exposed to the atmospheric air A. A base end opening 361 is formed as an atmospheric air introducing portion of the atmospheric duct 36 is formed at the base end portion of the sensor element 2 in the longitudinal direction L. The atmospheric duct 36 is formed from the base end opening 361 to a portion overlapping with the gas chamber 35 in the lamination direction D via the solid electrolyte 31. For the atmospheric duct 36, the atmospheric air A is introduced from the based end opening 361.

(Insulators 33A and 33B)

As shown in FIGS. 2 and 3, the first insulator 33A forms the gas chamber 35, and the second insulator 33B forms the atmospheric duct 36 and allows the heating element 34 to be embedded therein. The first insulator 33A and the second insulator 33B are formed of metal oxide such as aluminum (aluminum oxide). The insulators 33A and 33B are formed as a dense body through which the exhaust gas G or the atmospheric air A cannot permeate. For the insulators 33A and 33B, substantially no pores that allow gas to permeate therethrough are formed.

(Heater 22)

As shown in FIGS. 2 to 4, the heater 22 is formed of the heating element 34 embedded in the second insulator 33B. Note that the heating element 34 may be embedded in the first insulator 33A. The heating element 34 includes a heating section 341 for generating heat when being supplied with power, and a heating element lead 342 connected to the base end side L2 of the heating element 341 in the longitudinal direction L. For the heating section 341, at least a part of the heating section 341 is formed at a portion overlapping with the exhaust gas electrode 311 and the atmosphere side electrode 312 in the lamination direction D where the solid electrolyte 31 and the insulators 33A and 33B.

Further, the heating element 341 is formed of linear conductor meandering by a linear part and a curved part. The liner part of the heating section 341 according to the present embodiment is formed to be parallel to the longitudinal direction L. The heating element lead 342 is formed of a linear conductor parallel to the longitudinal direction L. The resistance of the heating element 341 per unit length is larger than the resistance of the heating element lead 342 per unit length. The heating element lead 342 is lead out from the heating element 341 to a portion of the base end side L2 in the longitudinal direction L. The heating element 34 contains a metal material having conductivity.

The heating element 341 is disposed at a portion facing the exhaust gas electrode 311 and the atmosphere side electrode 312 in the lamination direction D orthogonal to the longitudinal direction L. In other words, the heating section 341 is disposed in a tip end side L1 of the sensor element in the longitudinal direction L, at a portion overlapping with the exhaust gas electrode 311 and the atmosphere side electrode 312. In the case where a voltage is applied to a pair of heating element lead 342, the heating section 341 generates heat by Joule heat, and the sensor cell 21 and vicinity thereof are heated to a target temperature with this generated heat.

(Porous Layer 37)

As shown in FIG. 1, a porous layer 37 is provided on the sensor element 2 at an entire periphery of a portion in the tip end side L1 in the longitudinal direction L. The porous ceramic is for capturing poisoning substances of the exhaust gas electrode 311 and condensed water produced in the exhaust pipe 7. The porous layer 37 is formed of a porous ceramic (metal oxide) such as aluminum. The pore ratio of the porous layer 37 is larger than the pore ratio of the diffusion resistance section 32 and the flow rate of the exhaust gas G capable of permeating the porous layer 37 is larger than the flow rate of the exhaust gas G capable of permeating the diffusion resistance section 32.

(Other Sensor Element 2)

Although illustration is omitted, the sensor element 2 is not limited to one having a single solid electrolyte, but may be configured to have two or more solid electrolytes 31. The electrodes 311 and 312 provided on the solid electrolyte 31 is not limited to a pair of the exhaust gas electrode 311 and the atmosphere side electrode 312, but may be a plurality of pairs of electrodes. In the case where a plurality of pairs of electrodes are provided in one or more electrolytes 31, the heating section 341 of the heating element 34 may be provided at a portion facing the plurality of pair of electrodes.

Further, the sensor element 2 may be configured as a cup-type element provided with a solid electrolyte having a bottomed cylindrical shape, an exhaust electrode 311 disposed in an outer side surface of the solid electrolyte and an atmosphere side electrode 312 disposed in an inner side surface of the solid electrolyte. Also in this case, poisoning substances contained in the atmospheric air A acquired inside an atmosphere side cover 46A and 46B and flowing into the solid electrolyte, may possibly reach the atmosphere side electrode 312. Note that the cup-type sensor element 2 may be configured to detect electromotive force generated between the exhaust gas electrode 311 and the atmosphere side electrode 312 and to detect the air fuel ratio or NOx using a voltage application unit 62.

(Other Configuration of Gas Sensor 1)

As shown in FIG. 1, the gas sensor 1 is provided with, in addition to the sensor element 2, a first insulator 42 that supports the sensor element 2, a housing 41 that supports the first insulator 42, a second insulator 43 coupled to the first insulator 42 and a contact terminal 44 supported by the second insulator 43, contacting with the sensor element 2. Further, the gas sensor 1 is provided with an element cover 45A and 45B attached to a portion in the tip end side L1 of the housing 41, covering a tip end side portion of the sensor element 2, an atmosphere side cover 46A and 46B attached to a portion in the rear end side L2 of the housing 41, covering the second insulator 43 and the connection terminal 44, and a bush 47 for holding a lead 48 connected to the contact terminal 44 on the atmosphere side cover 46A and 46B.

The tip end side portion of the sensor element 2 and the element cover 45A and 45B are disposed in the exhaust pipe 7 of the engine 5. In the element cover 45A and 45B, a gas passage hole 451 is formed allowing the exhaust gas G as a gas to be detected to permeate therethrough. The element covers 45A and 45B are configured as a double structure of the inner cover 45A and the outer cover 45B covering the inner cover 45A. The element cover 45A and 45B may be configured as a single structure. The exhaust gas G flowing from the gas passage hole 451 of the element cover 45A and 45B to a portion inside the element cover 45A and 45B, permeates through the porous layer 37 and the diffusion resistance section 32 of the sensor element 2 to reach the exhaust gas electrode 311.

As shown in FIG. 1, the atmosphere side cover 46A and 46B is disposed outside the exhaust pipe 7 of the engine 5. The gas sensor 1 according to the present embodiment is utilized for vehicle in which a vehicle body including the exhaust pipe 7 disposed therein constitutes an engine compartment with the engine 5 disposed therein. Then, gases generated from various rubbers, resin, lubricant and the like in the engine compartment are mixed with the atmospheric air A and flow in the vicinity of the atmosphere side cover 46A and 46B. The gases generated in the engine compartment may be a poisoning substance (poisoning gas) causing poisoning of the atmosphere side electrode 312. The poisoning gas generated in the engine compartment or the like includes silicon (Si), sulfur (S) and the like.

The atmosphere side cover 46A and 46B are composed of a first cover 46A attached to the housing 41 and a second cover 46B that covers the first cover 46A. An atmospheric air passage hole 461 is formed at the first cover 46A and the second cover 46B for allowing the atmospheric air A to permeate therethrough. A water repellent filter 462 is interposed between the first cover 46A and the second cover 46B at a portion facing the air passage hole 461 in order to prevent water intrusion inside the first cover 46A.

The base end opening 361 of the atmospheric duct 36 in the sensor element 2 is opened to a space inside the atmosphere side cover 46A and 46B. The atmospheric air A existing in the vicinity of the atmospheric air passage hole 461 of the atmosphere side cover 46A and 46B is acquired inside the atmosphere side cover 46A and 46B via the water repellent filter 462. Then, the atmospheric air A passing through the water repellent filter 462 flows into the atmospheric duct 36 from the base end opening 361 of the atmospheric duct 36 of the sensor element 2 and lead to the atmosphere side electrode 312 of the atmospheric duct 36.

The theory of how the atmospheric air A containing poisoning gas such as siloxane is introduced to the atmospheric duct 36 where the atmosphere side electrode 312 is as follows. When the combustion of the engine 5 is stopped, the exhaust pipe 7 and the gas sensor 1 are gradually cooled from a state of being heated at high temperature. The temperature of the atmospheric air A inside the atmosphere side cover 46A and 46B decreases in response to a decrease in the temperature of the gas sensor 1, whereby the volume of the atmospheric air A inside atmosphere side cover 46A and 46 is reduced. At this moment, since the pressure inside the atmosphere side cover 46A and 46B is at a negative pressure smaller than the atmospheric pressure, the atmospheric air A containing poisoning gas generated in the engine compartment is introduced to a portion inside the atmosphere side cover 46A and 46B via the water repellent filter 462. Then, the atmospheric air A containing poisoning gas is introduced to the atmosphere side electrode 312 in the atmospheric duct 36 of the sensor element 2 from a portion inside the atmosphere side cover 46A and 46B.

Moreover, when the gas sensor 1 is used as an air fuel ratio sensor or the like, the voltage application unit 62 applies DC voltage between the exhaust gas electrode 311 and the atmosphere side electrode 312 such that the potential of the atmosphere side electrode 312 becomes positive side (higher voltage side). Then, when the air fuel ratio of the engine 5 is on a fuel lean side, oxide ions move from the exhaust gas electrode 311 towards the atmosphere side electrode 312 via the solid electrolyte 31. On the other hand, when the air fuel ratio of the engine is in a fuel rich side, oxide ions flow reversely towards the exhaust gas electrode 311 from the atmosphere side electrode 412 via the solid electrolyte 31 in order to react unburned gas in the exhaust gas electrode 411. At this moment, the atmospheric air A inside the atmosphere side cover 46A and 46B is sucked into the atmospheric duct 36 and the atmospheric air A containing poisoning gas introduced inside the atmosphere side cover 46A and 46B is introduced to the atmosphere side electrode 312 in the atmospheric duct 36.

(Poisoning Substances)

The poisoning substance may cause poisoning of the atmosphere side electrode 312. One of poisoning substances in the atmospheric air A may be siloxane gas generated in the engine compartment of the vehicle. The siloxane is a chemical compound in which silicon and oxygen are skeleton, and forms organic siloxane or the like. The atmospheric gas outside a pipe such as an exhaust pipe 7 on which the gas sensor 1 is disposed is likely to contain the atmospheric air A flowing from the engine compartment. The poisoning substances of the atmosphere side electrode 312 refers to substances adhered to the atmosphere side electrode 312, deteriorating characteristics of the atmosphere side electrode 312.

(Sensor Control Unit 6)

As shown in FIGS. 1, 2, 5 and 6, the sensor control unit 6 performs an electrical control in the gas sensor in cooperation with an engine control unit 50 that controls an combustion operation of the engine 5 in the vehicle. The sensor control unit 6 may be configured of various control circuits, a computer or the like. The sensor control unit 6 is composed of a heater control unit 61 that applies power to the heating element 34 included in the heater 22, a voltage application unit 62 that applies DC voltage between the exhaust gas electrode 311 and the atmosphere side electrode 312, a current measuring unit 63 that measures current flowing between the atmosphere side electrode 312 and the exhaust gas electrode 311 and the like. The air fuel ratio of the engine 5 is calculated based on the output current measured by the current measuring unit 63.

The gas sensor 1 and the sensor control unit 6 is configured to be able to operate not only in the combustion operation of the engine 5 but also in a combustion stopped state where the switch of the vehicle engine 5 is OFF. In other words, the gas sensor 1 and the sensor control unit 6 are configured to be driven in both a combustion operation and combustion stopped state. The heater control unit 61 is configured to, in the combustion operation, apply power to the heating element 34 of the heater 22 so as to maintain the sensor 21 to be at an operation control temperature T1.

An operation control temperature T1 of the sensor cell 21 according to the present embodiment is set to be in a range from 600° C. to 800° C. inclusive. The operation control temperature T1 is set to be a temperature for activating the conductivity to the oxide ions in the solid electrolyte 31. In the case where the operation control temperature T1 is less than 600° C., it is difficult to activate the solid electrolyte 31. In the case where the operation control temperature T1 exceeds 800° C., durability of the sensor element 2 including the solid electrolyte may be deteriorated.

The heater control unit 61 is configured to, in the combustion stopped state, apply power to the heating element 34 of the heater 22 so as to maintain the sensor 21 to be at an operation stop control temperature T2. The operation stop control temperature T2 is set to be in a range from 660° C. to 950° C. inclusive and higher than the operation control temperature T1. In the case where the operation stop control temperature T2 is less than 660° C., it is difficult to suppress poisoning of the atmosphere side electrode 312 or difficult to recover from poisoning of the atmosphere side electrode 312. In the case where the operation stop control temperature T2 exceeds 950° C., durability of the solid electrolyte 31 may be lowered.

A difference between the operation stop control temperature T2 and the operation control temperature T1 may preferably be 60° C. or more, more preferably be 100° C. or more and further more preferably be 150° C. or more.

Immediately after the combustion operation of the engine 5 is stopped, the temperature in the engine compartment is high, a wind caused by travelling of the vehicle and air-circulation by a radiator fan almost disappear. Thus, poisoning gas is likely to be produced in the engine compartment which influences the atmosphere side electrode 312. Further, poisoning gas produced in the engine compartment is likely to stay in the engine compartment. In the combustion stopped state, the heater control unit 61 may preferably start, immediately after stopping the combustion of the engine 5, to heat the sensor cell 21 to be at the operation stop control temperature T2. The heater control unit 61 may start the heating in the operation stopped state after a predetermined period elapses from a combustion stop of the engine 5.

For the gas sensor 1 mounted on a vehicle having no idling stop function, the heater control unit 61 may heat the sensor cell 21 to be at the operation stop control temperature T2 every time when the engine 5 is in a combustion stopped state. For the gas sensor 1 mounted on a vehicle having an idling stop function, the heater control unit 61 may heat the sensor cell 21 to be at the operation stop control temperature T2 every time when the engine 5 is in a combustion stopped state including a combustion stop due to the idling stop. On the other hand, according to the above gas sensor 1, the heater control unit 61 may heat the sensor cell 21 to be at the operation stop control temperature T2 every time when the engine 5 is in a combustion stopped state excluding a combustion stop due to the idling stop. The combustion stop of the engine 5 due to an idling stop may be determined by detecting a combustion start within 2 minutes elapsed from a combustion stop of the engine 5, for example.

(Treatment of Poisoning Substances on Atmosphere Side Electrode 312)

The heater control unit 61 is configured to heat the sensor cell 21 in the combustion stopped state to be at the operation stop control temperature T2, thereby destroying the poisoning substances adhered on the atmosphere side electrode 312. The poisoning substances according to the present embodiment are silicon oxides. The heater control unit 61 is configured to produce cracks in the silicon oxides by heating the sensor cell 21 to be at the operation stop control temperature T2.

In the case where the atmospheric air A containing siloxane contacts with the atmosphere side electrode 312, a poisoning film made of silicon oxide may be formed on the surface of the atmosphere side electrode 312. The poisoning film serves as an electrical insulator. In the case where the poisoning film is formed on the surface of the atmosphere side electrode 312, the atmosphere side electrode loses active sites for ionizing oxygen. In particular, for the air fuel ratio sensor, in the case where the air fuel ratio of the engine 5 is on a fuel rich side which causes oxide ion to reversely flow to the exhaust gas electrode 311 from the atmosphere side electrode 312, a detection accuracy of the air fuel ratio is deteriorated.

The deterioration of the detection accuracy of the air fuel ratio in the fuel rich side is illustrated by FIG. 7, for example. For the air fuel ratio operating normally, the output current changes in a range from a fuel lean side where the air fuel ratio is larger than 14.5 to a fuel rich side where the air fuel ratio is smaller than 14.5. On the other hand, when a poisoning film is formed on the atmosphere side electrode 312, a change in the output current of the sensor cell 21 indicating the air fuel ratio is unlikely to occur. In FIG. 7, a case of normal operation is shown with a solid line and a case where the poisoning film is formed is shown in with a dotted line. Note that a case where the air fuel ratio is smaller than 14.5 is indicated as a fuel rich side, and a case where the air fuel ration is larger than 14.5 is indicated as a fuel lean side.

According to the present embodiment, cracks are caused to be generated in the poisoning film formed of silicon oxide adhered to the atmosphere side electrode 312, thereby recovering active sites for ionizing oxygen on the atmosphere side electrode 312. The operation stop control temperature T2 according to the present embodiment is set to be a temperature higher than a temperature at which thermal stress produced on a boundary surface between the atmosphere side electrode 312 and the silicon oxide adhered to the atmosphere side electrode 312 is larger than a tensile stress inherent in the silicon oxide itself.

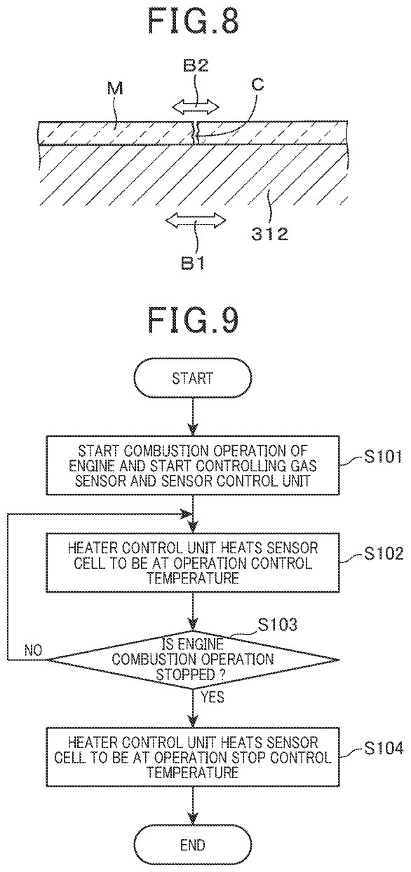

The atmosphere side electrode 312 according to the present embodiment is formed of platinum particles mixed with solid electrolyte particles. The linear expansion coefficient of the atmosphere side electrode 312 is larger than the linear expansion coefficient of the silicon oxide. As shown in FIG. 8, when the sensor cell 21 is heated, an amount of thermal expansion B1 of the atmosphere side electrode 312 is larger than an amount of thermal expansion B2 of a poisoning film M formed of the silicon oxide. At this moment, a thermal stress is produced between the atmosphere side electrode 312 and the poisoning film M, and the poisoning film M is pulled by the atmosphere side electrode 312. In the case where the thermal stress produced between the atmosphere side electrode 312 and the poisoning film M becomes larger than a tensile stress of the poisoning film M, microcrack C as minute cracks is produced on the poisoning film M.

The tensile stress of silica (SiO2) as a silicon oxide is 50N/mm2. Preferably, the operation stop control temperature T2 may be set to be 60° C. or more larger than the operation control temperature T1 in order to have the thermal stress produced between the atmosphere side electrode 312 and the poisoning film M exceed 50N/mm2.

In the case where the operation stop control temperature T2 for heating the sensor cell 21 becomes excessively high, a crystal structure of zirconia that constitutes the solid electrolyte 31 may change. For zirconia, three crystal systems of monoclinic, tetragonal and cubic are present, where the state is monoclinic at around normal temperature (25° C.), the state changes to tetragonal when the temperature increases and changes to cubic when the temperature becomes higher than that when the state is tetragonal. This state change of the crystal structure accompanies with a change in the volume. The state change from the monoclinic state to the tetragonal state accompanies with 4% of volumetric shrinkage.

The temperature at which the state of zirconia constituting the solid electrolyte 31 changes from the monoclinic state to the tetragonal state is in a range from 950° C. to 1200° C. inclusive. Thus, the operation stop control temperature T2 may preferably be set to be 950° or less as a temperature that causes no phase transition in the solid electrolyte 31.

In the light of the above, the operation stop control temperature T2 according to the present embodiment is set to be higher than a temperature at which the thermal stress produced on a boundary surface between the atmosphere side electrode 312 and the silicon oxide adhered to the atmosphere side electrode 312 is larger than the tensile stress of the silicon oxide itself and lower than a temperature at which the crystal structure of the solid electrolyte 31 changes. Then, the heater control unit 61 heats the sensor cell 21 during the combustion operation stop to be at the operation stop control temperature T2 and causes cracks in the poisoning film adhered to the atmosphere side electrode 312, whereby the detection accuracy of the air fuel ratio in the fuel rich side can be recovered.

(Control Method)

With reference to the flowchart shown in FIG. 9, a control method executed by the sensor control unit 6 of the gas sensor 1 will be described. First, in response to a turning-ON of the ignition switch of the vehicle, a combustion operation of the engine 5 is started (step S101). In response to the start of the combustion of the engine 5, a control operation is started for the gas sensor 1 and the sensor control unit 6 (step S101). Then, the heater control unit 61 of the sensor control unit 6 heats the sensor cell 21 to be at the operation control temperature T1 (step S102).

Next, when the ignition switch is turned OFF, the process determines whether the combustion operation of the engine 5 is stopped (step S103). The engine control unit 50 continues the combustion operation of the engine 5 in response to feedback of the air fuel ratio performed by the gas sensor 1 and the sensor control unit 6 until the ignition switch is turned OFF.

Subsequently, when the combustion operation of the engine 5 is stopped, the heater control unit 61 of the sensor control unit 6 heats the sensor cell 21 to reach the operation stop control temperature T2 (step S104). After the temperature of the sensor cell 21 reaches the operation stop control temperature T2 by heating the sensor cell 21 for a predetermined time, the heater control unit 61 stops heating.

In the case where the heater control unit 61 heats the sensor cell 21 to be at the operation stop control temperature T2 during the combustion stop in the engine 5, the voltage application unit 62 may apply a predetermined voltage between an exhaust gas electrode 311 and the atmosphere side electrode 312. The predetermined voltage may be set to be an operation voltage V1 which will be later described in the second embodiment.

(Effects and Advantages)

According to the sensor control unit 6 of the present embodiment, the heater control unit 61 that controls the heater 22 to heat the sensor cell 21 is improved. As a result, the atmosphere side electrode 312 is prevented from being poisoned or the atmosphere side electrode is recovered from poisoning. Specifically, the heater control unit 61 is configured to heat the sensor cell 21 to be at the operation stop control temperature T2 which is higher than the operation control temperature T1 during the combustion stop of the engine 5. With this configuration, poisoning gas such as siloxane gas is subjected to thermal oxidation in the atmospheric duct 36 such that the poisoning gas is unlikely to reach the atmosphere side electrode 312, whereby the poisoning film having insulation properties can be prevented from being formed on the atmosphere side electrode 312.

The heater control unit 61 heats the sensor cell 21 during the combustion stop in the engine 5, whereby inside the atmospheric cover 46A and 46B and the atmospheric duct 36 can be maintained at high temperature. Thus, the volume of the atmospheric air A inside the atmosphere side cover 46A and 46B is unlikely to be contracted and the atmospheric air A containing siloxane or the like is unlikely to reach the atmospheric electrode 312 in the atmospheric duct 36.

Also, it is expected that poisoning substances such as siloxane are already adhered to the atmospheric electrode 312 before activating the gas sensor 1 and the sensor control unit 6. In this state, when activating the gas sensor 1 and the sensor control unit 6, oxidation reaction of the poisoning substances occurs due to the heating of the atmosphere side electrode 312, and the poisoning substances may form a poisoning film. In this case, during the combustion stop of the engine 5, the sensor cell 21 is heated to be at the operation stop control temperature T2, whereby a thermal stress is applied to the poisoning film on the atmosphere side electrode 312 and the poisoning film is destroyed. Hence, a function of ion activation of oxygen by the atmosphere side electrode 312 can be recovered.

Thus, according to the sensor control unit 6 of the gas sensor 1, the atmosphere side electrode 312 of the gas sensor 1 can be prevented from poisoning. Further, in the case where the atmosphere side electrode 312 suffers from poisoning, the atmosphere side electrode 312 can be recovered from poisoning.

In FIG. 10, respective timing diagrams (a), (b), (c) and (d) show a change in the state of the vehicle and operation of the heater control unit 61 with respect to time. The timing (a) in FIG. 10 shows a change in the vehicle speed with respect to time. A period where the vehicle speed becomes temporarily zero indicates that the engine 5 is in an idling state. The timing (b) in FIG. 10 shows a change in the siloxane concentration in the engine compartment. The siloxane concentration increases when the engine 5 is in an idling state and when the combustion of the engine 5 is stopped. The idling state refers to a state where the engine 5 is in a combustion operation at a predetermined low engine speed when the vehicle speed is zero.

The timing (c) in FIG. 10 shows a change in an excess air ratio X of the engine 5 with respect to time. The excess air ratio tends to be higher as the vehicle speed approaches zero. The timing (d) in FIG. 10 shows a change in the heating temperature of the sensor cell 21. In the combustion operation of the engine 5, the sensor cell 21 is heated to be at the operation control temperature T1. In the case where the combustion operation of the engine 5 is stopped, the sensor cell 21 is heated to be at the operation stop control temperature T2.

According to the present embodiment, during the combustion stop of the engine 5 where a high siloxane concentration in the engine compartment continues for a long period, the sensor cell 21 is heated to be at the operation stop control temperature T2, whereby the atmosphere side electrode 312 can be prevented from poisoning. Further, in the case where the atmosphere side electrode 312 is poisoned, the atmosphere side electrode 312 can be recovered from poisoning.

The sensor cell 21 may be heated, when the engine 5 is in an idling state, by the heater control unit 61 and the heater 22 to be at the operation stop control temperature T2. Also in the case where the engine 5 becomes an idling stop state after the vehicle starts to travel, the siloxane concentration in the engine compartment becomes higher. Therefore, also in this case, by applying heat to the sensor cell 21 to be at the operation stop control temperature T2, the atmosphere side electrode 312 can be prevented from being poisoned or the atmosphere side electrode 312 can be recovered from poisoning.

### Second Embodiment

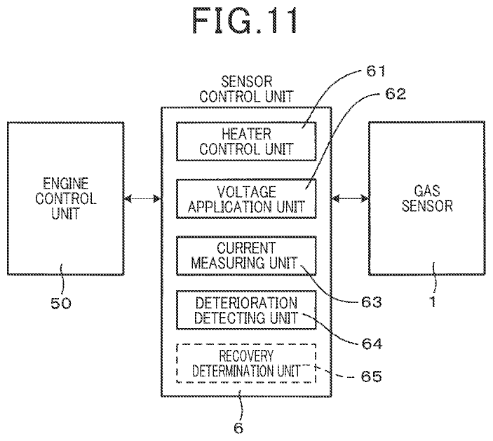

According to the second embodiment, recovering process from poisoning of the atmosphere side electrode 312 by the voltage application unit 62 of the sensor control unit 6 will be described. As shown in FIG. 2, the voltage application unit 62 according to the present embodiment is configured to apply DC voltage between the exhaust electrode 311 and the atmosphere side electrode 312 in which the atmosphere side electrode is set to be positive potential. Moreover, as shown in FIG. 11, the sensor control unit 6 according to the present embodiment includes a deterioration detecting unit 64 that detects a deterioration quantity of a detection value of the sensor cell 21 in a combustion operation or a combustion stopped state. The deterioration detecting unit 64 detects the deterioration quantity of a detection properties on a fuel rich side of the sensor cell 21 when the air fuel ratio of the engine 5 is on fuel rich side.

(Voltage Application Unit 62)

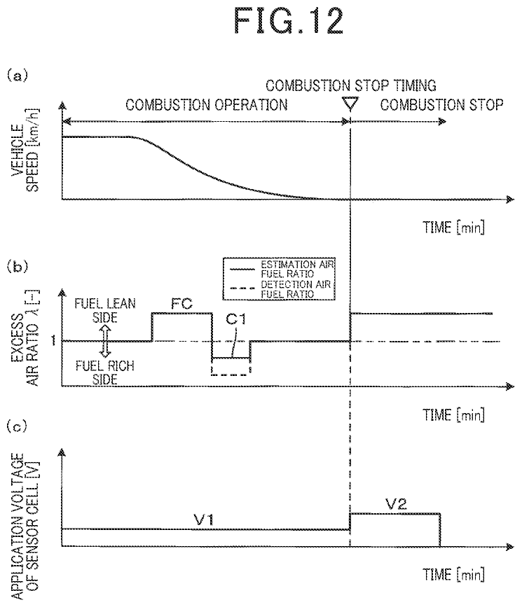

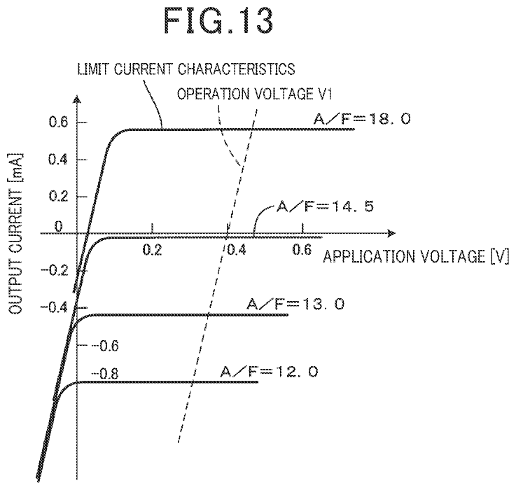

As shown in FIGS. 12 and 13, the voltage application unit 62 is configured to apply an operation voltage V1 between the exhaust gas electrode 311 and the atmosphere side electrode 312 in the combustion operation of the engine 5. The operation voltage V1 is set to be a voltage in which a relationship between the voltage and the current in the sensor cell 21 indicates the limit current characteristics or higher, and within a range lower than or equal to 0.6V. FIG. 13 shows limit current characteristics with a relationship between the application voltage and the output current of the sensor cell 21 when the air fuel ratio (A/F) changes.

In the limit current characteristics, the current flowing between the atmosphere side electrode 312 and the exhaust gas electrode 311 is limited when the diffusion resistance section 32 restricts introducing the exhaust gas G to the exhaust gas electrode 311 in the case where the voltage applied between the exhaust gas electrode 311 and the atmosphere side electrode 312 increases. In other words, the limit current voltage refers to a voltage where the current is constant even when the voltage changes. The lower limit value of the operation voltage V1 may be set to be 0.1V or larger. In the case where the operation voltage V1 is set to be larger than 0.6V, the sensor cell 21 is likely to be deteriorated.

As shown in FIG. 12, the voltage application unit 62 is configured to apply a stop voltage V2 higher than the operation voltage V1 between the exhaust gas electrode 311 and the atmosphere side electrode 312, under a condition where the deterioration quantity detected by the deterioration detecting unit 64 is larger than or equal to a predetermined value, so as to reduce the silicon oxide adhered to the atmosphere side electrode 312. The operation voltage V1 and the stop voltage V2 are applied relative to the atmosphere side electrode 312 as a positive potential. In the case where the deteriorated quantity detected by the deterioration detecting unit 64 is larger than or equal to the predetermined value, it is expected that a silicon oxide as a poisoning film may be formed the atmosphere side electrode 312. In this case, when the voltage application unit applies the stop voltage V2 between the exhaust gas electrode 311 and the atmosphere side electrode 312 during the combustion stop, silicon oxide is reduced, thereby removing the poisoning film from the atmosphere side electrode 312.

The stop voltage V2 is set to be in a range from a value exceeding 0.6V to a value of 1.2V or lower. In the case where the stop voltage V2 exceeds 0.6V, silicon oxide on the atmosphere side electrode 312 can be reduced. In the case where the stop voltage V2 exceeds 1.2V, a blacking phenomenon may occur on the solid electrolyte 31 which may case deterioration of the sensor cell 21. Blackening refers to a phenomenon in which zirconia or the like that constitutes the solid electrolyte 31 is reduced and zirconia or the like is metalized.

The stop voltage V2 according to the present embodiment is set to be higher than an oxidation potential of a noble metal contained in the atmosphere side electrode 312 and lower than a reduction potential of the solid electrolyte 31. The oxidation potential of the noble metal contained in the atmosphere side electrode 312 is in a range from a value exceeding 0.6V to a value 1.2V. The oxidation potential of the noble metal in the atmosphere side electrode 312 correlates to a principle of reducing silicon oxide adhered to the atmosphere side electrode 312.

Silica (SiO2) which is a silicon oxide as a poisoning film adhered to the atmosphere side electrode 312 is reduced as follows by applying DC voltage between the exhaust gas electrode 311 and the atmosphere side electrode 312. Specifically, platinum (Pt) as a noble metal contained in the atmosphere side electrode 312 is oxidized when applying DC voltage between the exhaust gas electrode 311 and the atmosphere side electrode 312 where the atmosphere side electrode 312 is set to be positive side (higher potential side). The oxidation reaction of the atmosphere side electrode 312 is expressed by a reaction formula below.

Pt→Pt²⁺+2e⁻

Then, electrons are transferred to silica from the atmosphere side electrode 312 so that silica is reduced utilizing electrons in the atmosphere side electrode 312. The reduction of silica in the atmosphere side electrode 312 is expressed by a reaction formula below.

SiO₂(Si⁴⁺)+4e⁻→Si+O₂

Thus, an oxidation occurred for platinum as a noble metal in the atmosphere side electrode 312 triggers an occurrence of reduction of silica as a silicon oxide in the atmosphere side electrode 312. With the reduction of silica, an active spot for ionizing oxygen in the atmosphere side electrode 312 is recovered.

The reduction voltage of the solid electrolyte 31 indicates a voltage at which blackening occurs on the solid electrolyte 31 and the stop voltage V2 ranges from 1V to 1.6V. The value of the reduction potential depends on the structure and the grain size of the microcrystal in zirconia that constitutes the solid electrolyte 31. The stop voltage V2 is set such that no blackening occurs on the solid electrolyte 31.

An application of the stop voltage V2 between the exhaust gas electrode 311 and the atmosphere side electrode 312 by the voltage application unit 62 may be stopped after continuing the voltage application for a predetermined period in the combustion stop. The predetermined period for applying the stop voltage V2, as a period necessary for reducing the silicon oxide adhered to the atmosphere side electrode 312, is determined in advance by conducting an experiment and the like. The predetermined period for applying the stop voltage V2 is set to be a minimum period necessary for reducing the silicon oxide adhered to the atmosphere side electrode 312, whereby the power consumption in the vehicle and a thermal load to the gas sensor 1 can be suppressed.

Also, the predetermined period for applying the stop voltage V2 may be appropriately changed based on an engine combustion period from when the combustion of the engine 5 starts to when the combustion is stopped, a travelling distance of the vehicle to which the gas sensor 1 is mounted, a sensor operating time of the gas sensor 1 and the sensor control unit 6 and a history data of the air fuel ratio of the engine 5. The longer the engine combustion period, the travelling distance of the vehicle or the sensor operating time, the larger the quantity of silicon oxide adhered to the atmosphere side electrode 312 is. Further, the longer the period where the air fuel ratio of the engine 5 is in a fuel rich side, the larger the quantity of silicon oxide adhered to the atmosphere side electrode 312 is.

The application of the stop voltage V2 between the exhaust gas electrode 311 and the atmosphere side electrode 312 by the voltage application unit 62 may be performed for one time or a plurality of divided times in the combustion stop.

(Deterioration Detecting Unit 64)

As shown in FIG. 12, the deterioration detecting unit 64 according to the present embodiment is configured to detect a deterioration quantity of a detection value of the sensor cell 21 in a neutralization control period C1 after performing a fuel cut operation FC that stops fuel supply to any of cylinders of the engine 5. After performing the fuel cut operation FC, a ratio of oxygen in the exhaust pipe 7 where the three-way catalyst is disposed, is higher than that in the stoichiometric state (theoretical air fuel ratio). In the neutralization control period C1, in order to have an environment where the three-way catalyst 72 is disposed in the exhaust pipe 7 after performing the fuel cut operation FC, to be substantially the stoichiometric state, an amount of fuel supply (fuel injection quantity) is controlled to be excessively large for the cylinder where the fuel supply is cutoff, compared to that in the case of theoretical air fuel ratio. At this moment, the air fuel ratio of the exhaust gas G detected by the gas sensor 1 is in the fuel rich side.

Further, the deterioration detecting unit 64 compares an estimated air fuel ratio estimated in accordance with a ratio between an amount of the fuel supply and an amount of air for the combustion, and the detection air fuel ratio detected in accordance with the output current of the gas sensor 1, and acquires a deterioration quantity of a detection value of the sensor cell 21 based on an amount of difference between the detection air fuel ratio and the estimated air fuel ratio. Since the estimated air fuel ratio is not influenced by a poisoning deterioration of the atmosphere side electrode 312, the estimated air fuel ratio is used as a reference value for the object of comparison.

In the case where a deterioration quantity of a detection value of the sensor cell 21 is large, it is expected that silicon oxide is adhered to the atmosphere side electrode 312. In the combustion stopped operation in which the combustion operation of the engine 5 is stopped, when the deterioration quantity of the detection value is larger than or equal to a predetermined value, the voltage application unit 62 applies a stop voltage V2 between the exhaust gas electrode 311 and the atmosphere side electrode 312. Thus, silicon oxide adhered to the atmosphere side electrode 312 is reduced.

In FIG. 12, timings (a), (b) and (c) indicate a state of the vehicle and a change in the operation of the voltage application unit 62. The timing (a) in FIG. 12 indicates a change in the vehicle speed. The timing (b) in FIG. 12 indicates a change in an excess air ratio X of the engine 5 with respect to time. The excess air ratio X is in a fuel lean side at the fuel cut state FC and thereafter the excess air ratio X is in a fuel rich side at the neutralization control period C1. In the neutralization control period C1, a difference between the estimated air fuel ratio and the detection air fuel ratio occurs. The timing (c) in FIG. 12 shows a change in the application voltage to the sensor cell 21 (between the exhaust gas electrode 311 and the atmosphere side electrode 312) applied by the voltage application unit 62. In the combustion operation of the engine 5, the operation voltage V1 is applied to the sensor cell 21, and in the combustion stopped operation of the engine 5, the stop voltage V2 is applied to the sensor cell 21.

(Other Configurations of Deterioration Detecting Unit 64)

For the deterioration detecting unit 64, when the voltage application unit 62 applies a predetermined voltage between the exhaust gas electrode 311 and the atmosphere side electrode 312, the current measuring unit 63 measures a current between the atmosphere side electrode 312 and the exhaust gas electrode 311, and the deterioration detecting unit 64 may detect a deterioration quantity of a detection value of the sensor cell 21 in accordance with an electrical resistance of the sensor cell 21 calculated based on the relationship between the above voltage and the current. It is considered that the larger an amount of silicon oxide adhered to the atmosphere side electrode 312, the higher the electrical resistance is. That is, the deterioration detecting unit 64 is able to determine the deterioration quantity such that the higher the electrical resistance, the larger the deterioration quantity is. Also, the deterioration detecting unit 64 may detect the deterioration quantity of the detection value of the sensor cell 21 in the combustion operation, and may detect the deterioration quantity of the detection value of the sensor cell 21 in the combustion stopped operation.

In the case where the deterioration detecting unit 64 performs a deterioration detection in the combustion operation, in a period where the voltage application unit 62 applies a voltage between the exhaust gas electrode 311 and the atmosphere side electrode 312 for the deterioration detection, the current flowing between the atmosphere side electrode 312 and the exhaust gas electrode 311 is not used as an output value of the sensor utilizing the limit current characteristics. Further, when performing the deterioration detection, the voltage applied between the exhaust gas electrode 311 and the atmosphere side electrode 312 can be set to be higher than the operation voltage V1.

In the case where the deterioration detecting unit 64 performs a deterioration detection in the combustion operation, when the combustion is stopped, the deterioration detecting unit 64 determines whether the deterioration quantity is larger than or equal to a predetermined value. In this combustion stopped state, the voltage application unit 62 may apply the stop voltage V2 between the exhaust gas electrode 311 and the atmosphere side electrode 312.

(Recovery Determination Unit 65)

As shown in FIG. 11, the sensor control unit 6 may include a recovery determination unit 65 that determines how much the deterioration quantity of the detection value of the sensor cell 21 is recovered when the stop voltage V2 is applied by the voltage application unit 62. The recovery determination unit 65 may detect electrical resistance between the exhaust gas electrode 311 and the atmosphere side electrode 312 when the voltage application unit 62 applies the stop voltage V2 between the exhaust gas electrode 311 and the atmosphere side electrode 312 and determine a recovery amount in the deterioration quantity of the detection value of the sensor cell 21 based on the detected electrical resistance. For the electrical resistance, the current measuring unit 63 may measure the current flowing between the atmosphere side electrode 312 and the exhaust gas electrode 411 when the voltage application unit 62 applies the stop voltage between the exhaust gas electrode 311 and the atmosphere side electrode 312, thereby detecting the electrical resistance. The voltage applied between the exhaust gas electrode 311 and the atmosphere side electrode 312 in order to detect the electrical resistance may be appropriately set based on the operation voltage V1 or the like. The recovery determination unit 65 may determine the recovery amount of the deterioration during the combustion stop.

Further, the recovery determination unit 65 may determine that the deterioration of the detection value of the sensor cell 21 is recovered when the electrical resistance is less than or equal to a predetermined threshold. The recovery determination unit 65 may repeatedly perform the voltage application and the current measurement (detection of the electrical resistance) for multiple times. The recovery determination unit 65 may determine that the deterioration of the detection value of the sensor value 21 is recovered under a condition where the electrical resistance is determined to be less than or equal to the predetermined value for the multiple times.

The voltage application unit 62 may continue to apply the stop voltage V2 between the exhaust gas electrode 311 and the atmosphere side electrode 312 in the combustion stop period until the recovery determination unit 65 determines that the deterioration of the detection value of the sensor cell 21 is recovered. That is, when the stop voltage V2 is being applied by the voltage application unit 62, the current flowing between the atmosphere side electrode 312 and the exhaust electrode 311 is measured continuously or intermittently, and the voltage application unit 62 may stop apply voltage when the electrical resistance acquired based on the stop voltage V2 and the current is less than or equal to the predetermined value.

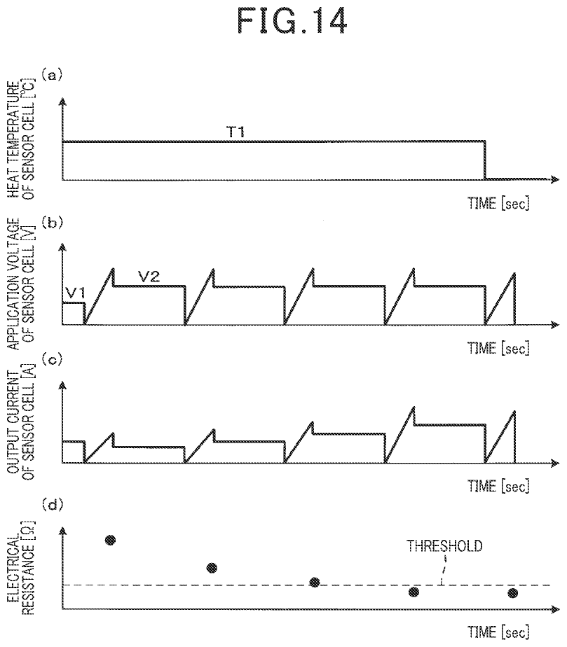

The timings (a), (b), (c), (d) in FIG. 14 show a change in the operation executed by the recovery determination unit 65. The timing (a) in FIG. 14 shows a change in the heating temperature of the sensor cell 21 which is heated by the heater control unit 61. The timing (b) in FIG. 14 shows a change in the voltage applied to the sensor cell 21 by the voltage application unit 62. In the case where the stop voltage V2 is intermittently applied to the sensor cell 21, voltage pulsation may occur. In FIG. 14, the timing (c) shows a change in the output current produced in the sensor cell 21. The output current produced in the sensor cell 21 shows an output current flowing between the atmosphere side electrode 312 and the exhaust gas electrode 311 via the solid electrolyte 31. The output current produced in the sensor cell 21 becomes larger every time when a deterioration of the atmosphere side electrode 312 is recovered due to voltage application of the stop voltage V2.

The timing (d) in FIG. 14 shows a change in the electrical resistance of the sensor cell 21. The electrical resistance of the sensor cell 21 becomes smaller every time when the deterioration of the atmosphere side electrode 312 is recovered due to a voltage application of the stop voltage V2. In accordance with a fact that the electrical resistance becomes lower than or equal to the predetermined threshold value, it is determined that poisoning deterioration of the atmosphere side electrode 312 is recovered.

Note that the deterioration detecting unit 64 and the recovery determination unit 65 may detect various physical property values correlated to poisoning due to silicon oxide of the atmosphere side electrode 312 other than detecting the electrical resistance between the exhaust gas electrode 311 and the atmosphere side electrode 312. Further, the deterioration detecting unit 64 and the recovery determination unit 65 may detect, based on the various physical property values, the deterioration quantity or the recovery amount.

Moreover, in the case where the heater control unit 61 heats the sensor cell 21 to be at the operation stop control temperature T2 as described in the first embodiment, the recovery determination unit 65 may be applied to a case utilizing both of a voltage application of the stop voltage V2 by the voltage application unit 62 and a heating of the sensor cell 21 to be at the stop temperature T2 by the heater control unit 61.

(Control Method)

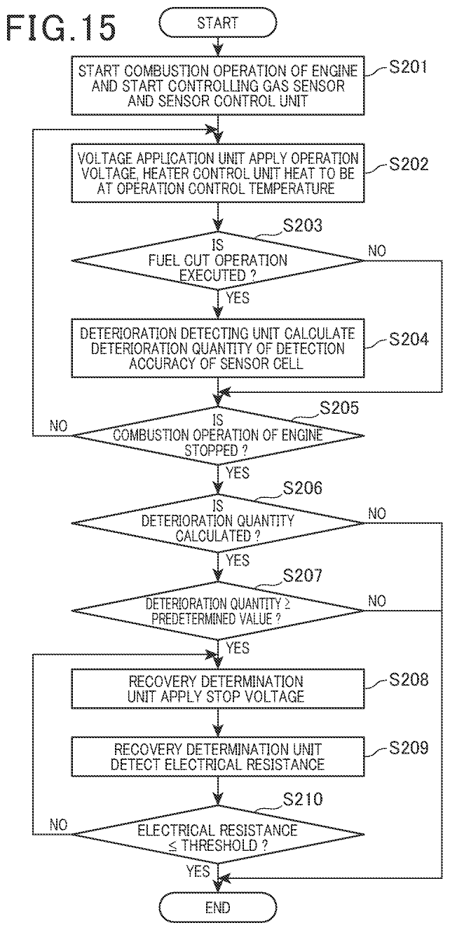

A control method executed by the sensor control unit 6 according to the present embodiment will be described with reference to FIG. 15. Firstly, in response to a turning-ON of an ignition switch of a vehicle, a combustion operation of the engine 5 starts (step S201). Further, in response to this operation, a control operation of the gas sensor 1 and the control unit 6 starts (step S201). Then, the voltage application unit 62 of the sensor control unit 6 applies an operation voltage V1 between the exhaust gas electrode 311 and the atmosphere side electrode 312, and the heater control unit 61 of the sensor control unit 6 heats the sensor cell 21 to be at the operation control temperature T1 (step S202).

Next, the sensor control unit 6 determines whether a fuel cut operation FC is executed (step S203). After performing the fuel cut operation FC, the deterioration detecting unit 64 compares the estimated air fuel ratio with the detection air fuel ratio, thereby calculating a deterioration quantity of a detection value of the sensor cell 21 (step S204). The deterioration detecting unit 64 calculates the deterioration quantity of the detection value of the sensor cell 21 based on an amount of difference acquired by comparing the estimated air fuel ratio with the detection air fuel ratio. In the case where the fuel cut operation FC is not performed, the deterioration detecting unit 64 does not calculate the deterioration quantity.

Next, in response to the switch OFF of the ignition switch, the process determines whether the combustion operation of the engine 5 is stopped (step S205). Then, until the ignition switch turns OFF, with feedback of the air fuel ratio from the gas sensor 1 and the sensor control unit 6, the combustion operation of the engine 5 continues.

Next, when the combustion operation of the engine 5 is stopped, the process determines whether the deterioration of the detection value of the sensor 21 has been calculated by the deterioration detecting unit 64 (step S206). In the case where the deterioration quantity has been calculated, the sensor control unit 6 determines whether the deterioration quantity is larger than or equal to the predetermines value (step S207). When the deterioration quantity is larger than or equal to the predetermined value, the voltage application unit 62 applies the stop voltage V2 between the exhaust gas electrode 311 and the atmosphere side electrode 312 for a predetermines period (step S208). At this moment, the recovery determination unit 65 detects, based on the current flowing between the exhaust gas electrode 311 and the atmosphere side electrode 312, an electrical resistance between the exhaust gas electrode 311 and the atmosphere side electrode 312 (step S209).

Then, the recovery determination unit 65 determines whether the detected electrical resistance is less than or equal to the predetermined threshold value (step S210). For the electrical resistance, the larger the deterioration quantity of the detection value of the sensor cell 21, that is, an amount of poisoning film adhered to the atmosphere side electrode 312, the higher the electrical resistance is. The predetermined threshold value of the electrical resistance may be set to be a value capable of determining correct electrical resistance of the sensor cell 21.

In the case where the detected electrical resistance is not less than or equal to the predetermined threshold value, the process determines that the deterioration of the detection value of the sensor cell 21 is not recovered, and the voltage application unit 62 again applies the stop voltage V2 between the exhaust gas electrode 311 and the atmosphere side electrode 312 for a predetermined period (step S208). Then, the recovery determination unit 65 again detects the electrical resistance between the exhaust gas electrode 311 and the atmosphere side electrode 312 based on the current flowing between the exhaust gas electrode 311 and the atmosphere side electrode 312 (step S209).

The voltage application unit 62 repeatedly applies the stop voltage V2 and detects the electrical resistance. In the case where the detected electrical resistance is less than or equal to the predetermined threshold, the voltage application unit 62 stops applying the stop voltage V2. Thus, with the application of the stop voltage V2, the silicon oxide adhered to the atmosphere side electrode 312 is reduced, and the deterioration of the detection value of the sensor cell 21 is recovered. When the deterioration quantity is not calculated at step S206, and when determined that the deterioration quantity is not larger than or equal to the predetermined value at step S207, the voltage application unit 62 does not apply the stop voltage V2.

In the case where the combustion operation of the engine 5 is stopped, when the voltage application unit 62 applies the stop voltage V2 between the exhaust gas electrode 311 and the atmosphere side electrode 312, the heater control unit 61 may heat the sensor cell 21 to be at a predetermined temperature. The predetermined temperature may be set to be the operation control temperature T1 described in the first embodiment.

(Effects and Advantages)

According to the sensor control unit 6 of the present embodiment, the voltage application unit 62 that applies the voltage between the exhaust gas electrode 311 and the atmospheric electrode 312 is improved to allow the atmosphere side electrode 312 to recover from the poisoning. Specifically, the voltage application unit 62 applies the stop voltage V2 which is higher than the operation voltage V1 between the exhaust gas electrode 311 and the atmosphere side electrode 312 under a condition where the deterioration quantity of the detection value of the sensor cell 21 acquired by the deterioration detecting unit 64 is larger than or equal to the predetermined value, thereby reducing the silicon oxide adhered to the atmosphere side electrode 312. With this configuration, silicon oxide as a poisoning film formed when the poisoning gas such as siloxane gas is adhered to the atmosphere side electrode 312 is reduced, whereby a function of ion activation of oxygen by the atmosphere side electrode 312 can be recovered.

Other configurations and effects and advantages in the gas sensor 1 and the sensor control unit 6 according to the present embodiment are the same as those in the gas sensor 1 and the sensor control 6 according to the first embodiment. Also in the present embodiment, elements indicated by the same reference numbers as those in the first embodiment are the same as the elements in the first embodiment.

### Third Embodiment

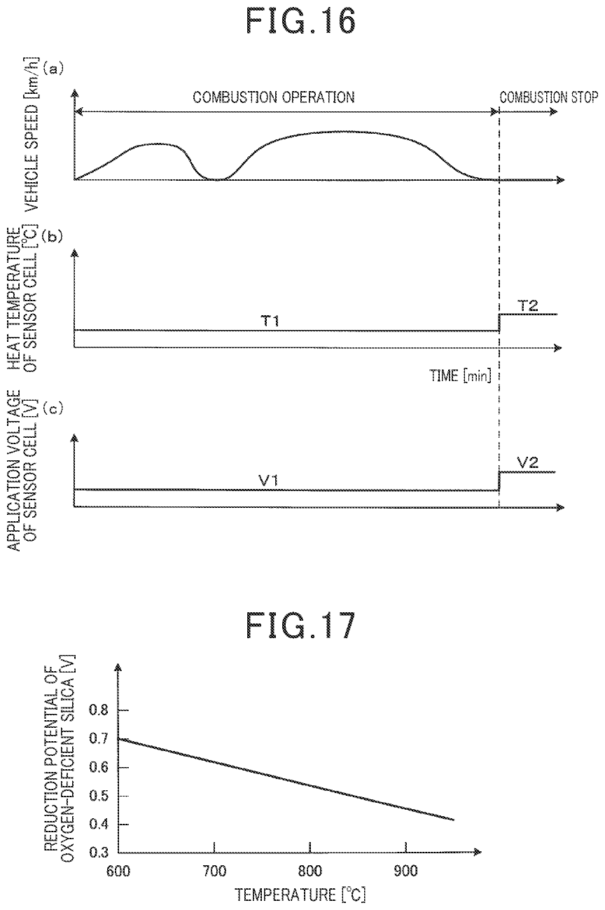

According to the present embodiment, a case will be described in which the heater control unit 61 and the voltage application unit 62 in the sensor control unit 6 are utilized for preventing poisoning on the atmosphere side electrode 312 and for recovering from poisoning on the atmosphere side electrode 312. As shown in timings (a), (b) and (c) in FIG. 16, the sensor control unit 6 according to the present embodiment, the heater control unit 61 is configured to, during the combustion stop, heat the sensor cell 21 to be at the operation stop control temperature T2 and cause the voltage application unit 62 to apply the stop voltage V2 between the exhaust gas electrode 311 and the atmosphere side electrode 312. Then, with this configuration to heat the sensor cell 21 to be at the operation stop control temperature T2 and to apply the stop voltage V2 to the sensor cell 21 (between electrodes 311 and 312), silicon oxide adhered to the atmosphere side electrode 312 is reduced.

The timing (a) in FIG. 16 shows a change in the vehicle speed. The timing (b) in FIG. 16 shows a change in the heating temperature of the sensor 21 applied by the heater control unit 61. The sensor 21 is heated to be at the operation control temperature T1 during the combustion operation of the engine 5, and the sensor 21 is heated to be at the operation stop control temperature T2 during the combustion stop period of the engine 5. The timing (c) in FIG. 16 shows a change in the voltage applied to the sensor 31 by the voltage application unit 62. The sensor cell 21 is applied with the operation voltage V1 during the combustion operation of the engine 5 and is applied with the stop voltage V2 during the combustion stop period of the engine 5.

As described above, the stop voltage V2 is applied between the exhaust gas electrode 311 and the atmosphere side electrode 312, whereby silica (SiO₂) which is a silicon oxide as a poisoning film formed on the atmosphere side electrode 312 is reduced. The reduction potential of silica has characteristics such that the higher the temperature of the atmosphere side electrode 312, the lower the reduction potential is. In other words, the higher the temperature of the atmosphere side electrode 312, the more readily the silica adhered to the atmosphere side electrode 312 is reduced at lower voltage.

The silica is produced by thermal oxidation of siloxane in which oxygen deficiency occurs thermodynamically at a certain degree. The reduction potential of silica where the oxygen deficiency occurs is considered to be lower than the reduction potential of normal silica. FIG. 17 shows a relationship between the temperature and the reduction potential of silica where the oxygen deficiency occurs. In a temperature range of the atmosphere side electrode 312 and silica from 660° C. to 950° C., the higher the temperature, the lower the reduction potential of silica where the oxygen deficiency occurs. This reduction potential changes from approximately 0.65V to approximately 0.42V.

The operation stop control temperature T2 and the stop voltage V2 are determined with the reduction potential of silica. Specifically, the stop voltage V2 is set to be larger than the reduction voltage of silica at a predetermined temperature in a range of the stop control temperature T2 from 660° C. to 950° C. inclusive. Further, the stop control temperature T2 is set such that the stop voltage V2 is higher than the reduction potential of silica at the stop control temperature T2.

(Control Method)

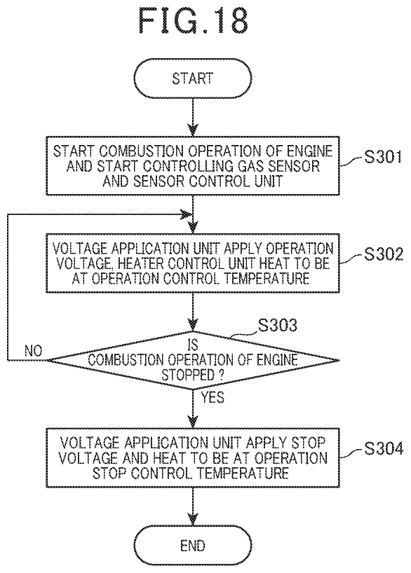

With reference to a flowchart shown in FIG. 18, a control method executed by the sensor control unit 6 according to the present embodiment will be described. Firstly, in response to a turning-ON of the ignition switch of the vehicle, a combustion operation of the engine 5 starts (step S301). Also, in response to this combustion start, a control operation is started for the gas sensor 1 and the sensor control unit 6 (step S301). Then, the voltage application unit 62 applies the operation voltage V1 between the exhaust gas electrode 311 and the atmosphere side electrode 312 of the sensor cell 21, and the heater control unit 61 heats the sensor cell 21 to be at the operation control temperature T1 (step S302).

Subsequently, in response to the switch OFF of the ignition switch, the process determines whether the combustion operation of the engine 5 is stopped (step S303). Then, until the ignition switch turns OFF, with feedback of the air fuel ratio from the gas sensor 1 and the sensor control unit 6, the combustion operation of the engine 5 continues.

Next, when the combustion operation of the engine 5 is stopped, the voltage application unit 62 applies the stop voltage V2 between the exhaust gas electrode 311 and the atmosphere side electrode 312 and the heater control unit 61 heats the sensor cell 21 to be at the operation stop control temperature T2 (step S304). Then, after a predetermined period elapses, the voltage application unit 62 stops voltage application and the heater control unit 61 stops heating.

(Effects and Advantages)

In the sensor control unit 6 according to the present embodiment, the stop voltage V2 is applied by the voltage application unit 62 and the heater control unit 61 heats the sensor control unit 21 to be at the operation stop control temperature T2. Hence, the atmosphere side electrode 312 can be effectively prevented from being poisoned or the atmosphere side electrode 312 can be effectively recovered from poisoning. Other configurations and effects and advantages in the gas sensor 1 and the sensor control unit 6 according to the present embodiment are the same as those in the gas sensor 1 and the sensor control unit 6 according to the first and second embodiments. Also in the present embodiment, elements indicated by the same reference numbers as those in the first and second embodiments are the same as the elements in the first and second embodiments.

### Forth Embodiment

According to the present embodiment, a case will be described in which the heater control unit 61 in the sensor control unit 6 is utilized for recovering from poisoning on the atmosphere side electrode 312. As shown in FIG. 11, the sensor control unit 6 includes a deterioration detecting unit 64 that detects a deterioration quantity of a detection value of the sensor cell 21 during the combustion operation or the combustion stop state. In the deterioration detecting unit 64 according to the present embodiment, when the voltage application unit 62 applies a predetermined voltage between the exhaust electrode 311 and the atmosphere side electrode 312, the current measuring unit 63 measures current flowing between the exhaust gas electrode 311 and the atmosphere side electrode 312, the deterioration quantity of the detection value of the sensor cell 21, that is, the deterioration quantity of the atmosphere side electrode 312, is detected based on the electrical resistance calculated in accordance with a relationship between the above voltage and current.

It is considered that the larger an amount of silicon oxide adhered to the atmosphere side electrode 312, the higher the electrical resistance is. Hence, it can be determined that the higher the electrical resistance, the larger the deterioration quantity is. The heater control unit 61 according to the present embodiment is configured to heat the sensor cell 21 during the combustion stop to be at the operation stop control temperature T2 under a condition where the deterioration quantity detected by the deterioration detecting unit 64 is larger than or equal to a predetermined value. Note that the configuration of the deterioration detecting unit 64 may be the same as the deterioration detecting unit 64 described in the second embodiment.

(Control Method)

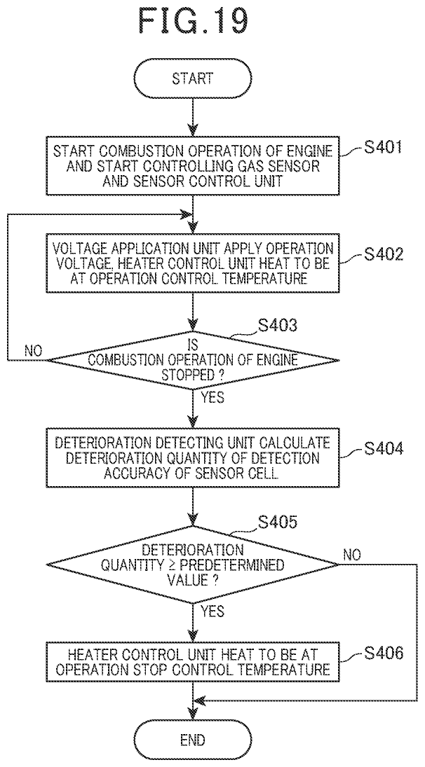

With reference to the flowchart shown in FIG. 19, a control method executed by the sensor control unit 6 according to the present embodiment will be described. Firstly, in response to a turning-ON of the ignition switch of the vehicle, a combustion operation of the engine 5 starts (step S401). Also, in response to this combustion start, a control operation is started for the gas sensor 1 and the sensor control unit 6 (step S401). Then, the voltage application unit 62 applies the operation voltage V1 between the exhaust gas electrode 311 and the atmosphere side electrode 312 of the sensor cell 21, and the heater control unit 61 heats the sensor cell 21 to be at the operation control temperature T1 (step S402).

Next, in response to the switch OFF of the ignition switch, the process determines whether the combustion operation of the engine 5 is stopped (step S403). Then, until the ignition switch turns OFF, with feedback of the air fuel ratio from the gas sensor 1 and the sensor control unit 6, the combustion operation of the engine 5 continues.

Next, when the combustion operation of the engine 5 is stopped, the deterioration detecting unit 64 applies a predetermined voltage lower than the stop voltage V2 between the exhaust gas electrode 311 and the atmosphere side electrode 312 to acquire the electrical resistance of the sensor cell 2, thereby calculating the deterioration quantity of the atmosphere side electrode (step S404). Subsequently, the sensor control unit 6 determines whether the deterioration quantity of the atmosphere side electrode 312 is larger than or equal to the predetermined quantity (step S405). Then, when the deterioration quantity of the atmosphere side electrode 312 is larger than or equal to the predetermined quantity, the heater control unit 61 heats the sensor cell 21 to be at the operation stop control temperature T2 (step S406).

Then, the heater control unit 61 stops heating after heating for a predetermined period to be at the operation stop control temperature T2. In the case where the deterioration quantity of the atmosphere side electrode 312 is not larger than or equal to the predetermined quantity, the heater control unit 61 does not heat for changing the temperature to be at the stop control temperature T2.

(Effects and Advantages)

According to the sensor control unit 6 of the present embodiment, the sensor cell 21 is heated to be at the operation stop control temperature T2 only when the deterioration detecting unit 64 detects a deterioration of the atmosphere side electrode 312, thereby recovering from the deterioration of the atmosphere side electrode 312. Thus, the sensor cell 21 is heated to be at the stop control temperature T2 which is higher than the operation control temperature T1 only when the detection value of the sensor cell 21 is required to be recovered. Hence, the sensor cell 21 can be prevented from being unnecessarily heated at high temperature.

Other configurations and effects and advantages in the gas sensor 1 and the sensor control unit 6 according to the present embodiment are the same as those in the gas sensor 1 and the sensor control unit 6 according to the first to third embodiments. Also in the present embodiment, elements indicated by the same reference numbers as those in the first to third embodiments are the same as the elements in the first to third embodiments.

### Fifth Embodiment

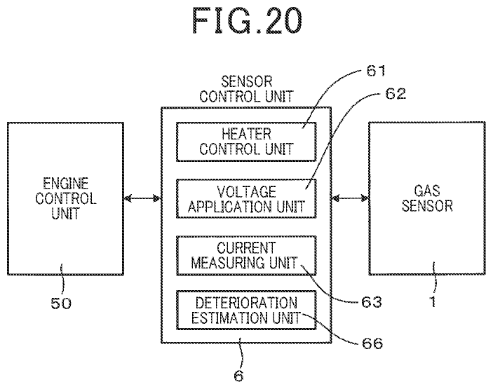

According to the present embodiment, a case will be described in which the heater control unit 61 in the sensor control unit 6 is utilized for recovering from poisoning on the atmosphere side electrode 312. As shown in FIG. 20, the sensor control unit 6 according to the present embodiment includes a deterioration estimation unit 66 that estimates a deterioration degree of the sensor cell 21 depending on the usage of the engine 5 or the gas sensor 1. The deterioration estimation unit 66 estimates the deterioration degree of the sensor cell 21 based on at least one of the number of combustion stops of the engine 5 from a time when the sensor cell 21 is heated to reach the operation stop control temperature T2 when the combustion is stopped, a travelling distance of the vehicle with the gas sensor mounted thereon, and the usage time of the gas sensor 1 and the sensor control unit 6.

The adherence of silicon oxide to the atmosphere side electrode 312 frequently occurs when the engine 5 is stopped, whereby an amount of adherence of silicon oxide increases when the number of combustion stops of the engine 5 increases. For the deterioration degree of the sensor cell 21, the larger the amount of adherence of the silicon oxide on the atmosphere side electrode 312, the larger (more deteriorated) the deterioration degree of the sensor cell 21 is. Further, the longer the travelling distance of the vehicle with the gas sensor 1 mounted thereon or the usage time of the gas sensor 1 and the sensor control unit 6, the larger the number of combustion stops of the engine 5 is. Therefore, the travelling distance or the usage time may be used instead of the number of combustion stops of the engine 5.

Further, as the air fuel ratio of the engine 5 approaches the fuel rich side relative to the theoretical air fuel ratio, silicon oxide is likely to be adhered to the atmosphere side electrode 312. By utilizing this phenomenon, the deterioration degree may be corrected to be larger as history data of the air fuel ratio is closer to the fuel rich side.

The heater control unit 61 according to the present embodiment is configured to heat the sensor cell 21 to be at the operation stop control temperature T2 during the combustion stop under a condition where the deterioration degree estimated by the deterioration estimation unit 66 is larger than or equal to a predetermined value. The deterioration estimation unit 66 according to the present embodiment is configured to count the number of combustion stops of the engine 5 and store it every time when the combustion of the engine 5 is stopped. Then, the deterioration estimation unit 66 estimates that the deterioration degree of the sensor cell 21 is larger than or equal to the predetermined value when the number of combustion stops reaches a predetermined number or more.

In the case where the gas sensor 1 and the sensor control unit 6 are mounted on a vehicle having an idling stop function, as described in the first embodiment, the number of combustion stops of the engine 5 due to an idling stop may be excluded from the number of combustion stops in the deterioration estimation unit 66.

(Control Method)

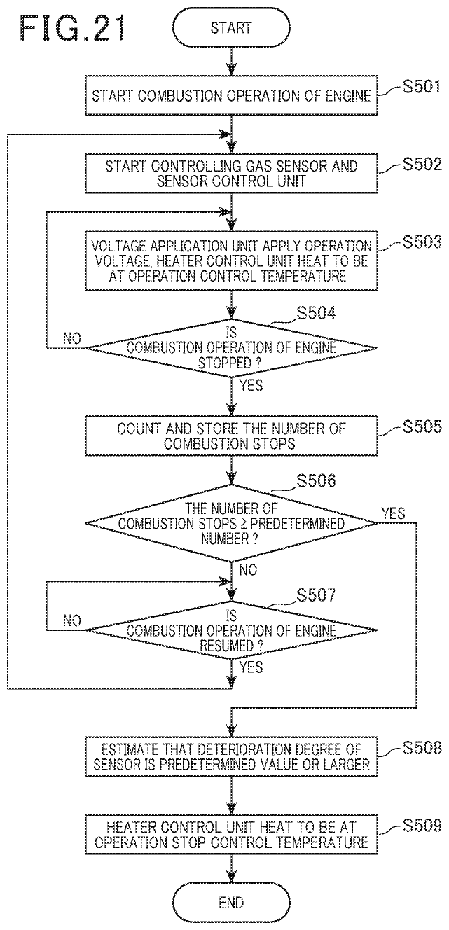

With reference to a flowchart shown in FIG. 21, a control method of the sensor control unit 6 according to the present embodiment will be described. Firstly, in response to a turning-ON of the ignition switch of the vehicle, a combustion operation of the engine 5 starts (step S501). Also, in response to this combustion start, a control operation is started for the gas sensor 1 and the sensor control unit 6 (step S502). Then, the voltage application unit 62 applies the operation voltage V1 between the exhaust gas electrode 311 and the atmosphere side electrode 312 of the sensor cell 21, and the heater control unit 61 heats the sensor cell 21 to be at the operation control temperature T1 (step S503).

Next, in response to the switch OFF of the ignition switch, the process determines whether the combustion operation of the engine 5 is stopped (step S504). Then, until the ignition switch turns OFF, with feedback of the air fuel ratio from the gas sensor 1 and the sensor control unit 6, the combustion operation of the engine 5 continues.

Subsequently, when the combustion operation of the engine 5 is stopped, the process counts the number of combustion stops and stores it (step S505). Next, the process determines whether the number of combustion stops reaches the predetermined number or larger (step S506). In the case where the number of combustion stops does not reach the predetermined number or larger, the process waits until the combustion operation of the engine 5 is resumed (step S507). Next, when the combustion operation of the engine 5 is resumed, processes at steps S502 to S507 are executed until the number of combustion stops of step S505 reaches the predetermined number or larger.

Next, in the case where the number of combustion stops reaches the predetermined number or larger, the deterioration estimation unit 66 estimates that the degree of deterioration degree of the sensor cell 21 is predetermined value or larger (step S508). Subsequently, the heater control unit 61 heats the sensor cell 21 to be at the operation stop control temperature T2 (step S509). Then, the heater control unit 61 stops heating after heating for a predetermined period to be at the operation stop control temperature T2.

Note that, the deterioration estimation unit 66 may estimate the deterioration degree during the combustion operation, and may heat the sensor cell 21 to be at the operation stop control temperature T2 during the combustion stop.

(Effects and Advantages)

According to the sensor control unit 6 of the present embodiment, the sensor cell 21 is heated to be at the operation stop control temperature T2 only when the deterioration estimation unit 66 detects a deterioration of the sensor cell 21, thereby recovering from the deterioration of the atmosphere side electrode 312. Thus, the sensor cell 21 is heated to be at the operation stop control temperature T2 which is higher than the operation control temperature T1 only when the detection value of the sensor cell 21 is required to be recovered. Hence, the sensor cell 21 can be prevented from being unnecessarily heated at high temperature.

Other configurations and effects and advantages in the gas sensor 1 and the sensor control unit 6 according to the present embodiment are the same as those in the gas sensor 1 and the sensor control unit 6 according to the first to third embodiments. Also in the present embodiment, elements indicated by the same reference numbers as those in the first to third embodiments are the same as the elements in the first to third embodiments.

The present disclosure is not limited to the above-described respective embodiments, but may constitute further different embodiments without departing from the spirit of the present disclosure. Moreover, the present disclosure includes various modification examples and equivalents thereof. Furthermore, various combinations of elements and embodiments which are expected from the present disclosure may be included in the technical scope of the present disclosure.

### Conclusion

The present disclosure provides a sensor control unit capable of suppressing poisoning of an atmosphere side electrode or recovering the atmosphere side electrode from being poisoned.

One aspect of the present disclosure is a sensor control unit used for a gas sensor disposed in an exhaust pipe in an internal combustion engine of a vehicle, the gas sensor having a sensor cell provided with an exhaust gas electrode exposed to an exhaust gas, an atmosphere side electrode exposed to atmospheric air and a solid electrolyte interposed therebetween on which the exhaust gas electrode and the atmosphere side electrode are disposed facing each other, and a heater that heats the sensor cell. The sensor control unit includes: a heater control unit that controls the heater for heating the sensor cell. The heater control unit heats, during a combustion operation of the internal combustion engine, the sensor cell to be at an operation control temperature, and heats, during a combustion stop period of the internal combustion engine, the sensor cell to be at an operation stop control temperature which is higher than the operation control temperature.

Another aspect of the present disclosure is a sensor control unit used for a gas sensor disposed in an exhaust pipe in an internal combustion engine of a vehicle, the gas sensor having a sensor cell provided with an exhaust gas electrode exposed to an exhaust gas, an atmosphere side electrode exposed to atmospheric air and a solid electrolyte interposed therebetween on which the exhaust gas electrode and the atmosphere side electrode are disposed facing each other, and a heater that heats the sensor cell. The sensor control unit includes: a voltage application unit that applies DC voltage between the exhaust gas electrode and the atmosphere side electrode; and a deterioration detecting unit that detects, during a combustion operation or a combustion stop period of the internal combustion engine, a deterioration quantity of a detection value of the sensor cell. The voltage application unit is configured to apply an operation voltage between the exhaust gas electrode and the atmosphere side electrode during the combustion operation, and apply a stop voltage higher than the operation voltage between the exhaust gas electrode and the atmosphere side electrode during the combustion stop period under a condition where the deterioration quantity detected by the deterioration detecting unit is larger than or equal to a predetermined value, thereby reducing silicon oxide adhered to the atmosphere side electrode.

(Sensor Control Unit According to One Aspect)

According to the sensor control unit of the above-described one aspect, the heater control unit that controls the heater to heat the sensor cell is improved such that the poisoning on the atmosphere side electrode is suppressed or the atmosphere side electrode can be recovered from poisoning. Specifically, the heater control unit is configured to heat, during the combustion stop of the internal combustion engine, the sensor cell to be at the operation stop control temperature higher than the operation control temperature in the combustion operation. With this configuration, a poisoning gas such as siloxane is oxidized in the gas sensor and is unlikely to reach the atmosphere side electrode, whereby a poisoning film having insulation properties can be prevented from being formed on the atmosphere side electrode.

Also, it is expected that poisoning substances such as siloxane are already adhered to the atmospheric electrode before activating the gas sensor and the sensor control unit. With this state, when activating the gas sensor and the sensor control unit, oxidation reaction of the poisoning substances occur by the heating of the atmosphere side electrode, and the poisoning substances may form a poisoning film. In this case, during the combustion stop of the engine, the sensor cell is heated to be at the operation stop control temperature, whereby a thermal stress is applied to the poisoning film on the atmosphere side electrode and the poisoning film is destroyed. Hence, a function of ion activation of oxygen by the atmosphere side electrode can be recovered.

The sensor control unit of the above aspect is capable of suppressing an atmosphere side electrode from being poisoned or recovering the atmosphere side electrode from being poisoned.

(Sensor Control Unit According to Another Aspect)

According to the sensor control unit of the above-described another aspect, the voltage application unit that applies a voltage between the exhaust gas electrode and the atmosphere side electrode is improved allowing the atmosphere side electrode to be to recovered from poisoning. Specifically, the voltage application unit applies the stop voltage which is higher than the operation voltage between the exhaust gas electrode and the atmosphere side electrode under a condition where the deterioration quantity of the detection value of the sensor cell detected by the deterioration detecting unit is larger than or equal to the predetermined value, thereby reducing the silicon oxide adhered to the atmosphere side electrode. With this configuration, the silicon oxide as a poisoning film formed when the poisoning gas such as siloxane gas is adhered to the atmosphere side electrode is reduced, whereby a function of ion activation of oxygen by the atmosphere side electrode can be recovered.

The sensor control unit of the above another aspect is capable of recovering the atmosphere side electrode of the gas sensor from poisoning.

What is claimed is:

1. A sensor control unit for a gas sensor disposed in an exhaust pipe in an internal combustion engine of a vehicle, the gas sensor having a sensor cell provided with an exhaust gas electrode exposed to an exhaust gas, an atmosphere side electrode exposed to an atmospheric air and a solid electrolyte interposed therebetween on which the exhaust gas electrode and the atmosphere side electrode are disposed facing each other, and a heater that heats the sensor cell,
the sensor control unit comprising:
a heater control unit that controls the heater for heating the sensor cell, the heater control unit heating, during combustion operation of the internal combustion engine, the sensor cell to be at an operation control temperature, and heating, during a combustion stop period of the internal combustion engine, the sensor cell to be at an operation stop control temperature higher than the operation control temperature; and
a deterioration estimation unit that estimates a deterioration degree of the sensor cell based on at least one of the number of combustion stops of the internal combustion engine from a time when the sensor cell is heated to reach the operation stop control temperature during the combustion operation or the combustion stop period, a travelling distance of the vehicle with the gas sensor mounted thereon, and a usage time of the gas sensor and the sensor control unit,
wherein
the heater control unit is configured to heat the sensor cell during the combustion stop period to be at the operation stop control temperature, under a condition where the deterioration degree estimated by the deterioration estimation unit is larger than or equal to a predetermined value.

2. A sensor control unit for a gas sensor disposed in an exhaust pipe in an internal combustion engine of a vehicle, the gas sensor having a sensor cell provided with an exhaust gas electrode exposed to an exhaust gas, an atmosphere side electrode exposed to an atmospheric air and a solid electrolyte interposed therebetween on which the exhaust gas electrode and the atmosphere side electrode are disposed facing each other, and a heater that heats the sensor cell,
the sensor control unit comprising:
a heater control unit that controls the heater for heating the sensor cell, wherein
the heater control unit heats, during combustion operation of the internal combustion engine, the sensor cell to be at an operation control temperature, and heats, during a combustion stop period of the internal combustion engine, the sensor cell to be at an operation stop control temperature higher than the operation control temperature; and
the heater control unit is configured to produce cracks in a silicon oxide adhered to the atmosphere side electrode by heating the sensor cell to be at the operation stop control temperature.

3. A sensor control unit for a gas sensor disposed in an exhaust pipe in an internal combustion engine of a vehicle, the gas sensor having a sensor cell provided with an exhaust gas electrode exposed to an exhaust gas, an atmosphere side electrode exposed to an atmospheric air and a solid electrolyte interposed therebetween on which the exhaust gas electrode and the atmosphere side electrode are disposed facing each other, and a heater that heats the sensor cell,
the sensor control unit comprising:
a heater control unit that controls the heater for heating the sensor cell, wherein
the heater control unit heats, during combustion operation of the internal combustion engine, the sensor cell to be at an operation control temperature, and heats, during a combustion stop period of the internal combustion engine, the sensor cell to be at an operation stop control temperature higher than the operation control temperature; and
the operation stop control temperature is set to be a temperature higher than a temperature at which a thermal stress produced on a boundary surface between the atmosphere side electrode and the silicon oxide adhered to the atmosphere side electrode is larger than a tensile stress inherent in the silicon oxide itself and lower than a temperature at which a crystal structure of the solid electrolyte changes.

4. A sensor control unit for a gas sensor disposed in an exhaust pipe in an internal combustion engine of a vehicle, the gas sensor having a sensor cell provided with an exhaust gas electrode exposed to an exhaust gas, an atmosphere side electrode exposed to an atmospheric air and a solid electrolyte interposed therebetween on which the exhaust gas electrode and the atmosphere side electrode are disposed facing each other, and a heater that heats the sensor cell,
the sensor control unit comprising:
a heater control unit that controls the heater for heating the sensor cell; and
a voltage application unit that applies DC voltage between the exhaust gas electrode and the atmosphere side electrode,
wherein
the heater control unit heats, during combustion operation of the internal combustion engine, the sensor cell to be at an operation control temperature, and heats, during a combustion stop period of the internal combustion engine, the sensor cell to be at an operation stop control temperature higher than the operation control temperature; and
the voltage application unit is configured to apply an operation voltage between the exhaust gas electrode and the atmosphere side electrode during the combustion operation and apply a stop voltage higher than the operation voltage between the exhaust gas electrode and the atmosphere side electrode during the combustion stop period.

5. The sensor control unit according to claim 4, wherein
the heater control unit heats the sensor cell during the combustion stop period to be at the operation stop control temperature and the voltage application unit applies the stop voltage between exhaust gas electrode and the atmosphere side electrode during the combustion stop period, thereby reducing the silicon oxide adhered to the atmosphere side electrode.

6. The sensor control unit according to claim 4, wherein
the stop voltage is set to be higher than an oxidation potential of a noble metal contained in the atmosphere side electrode and lower than a reduction potential of the solid electrolyte.

7. A sensor control unit used for a gas sensor disposed in an exhaust pipe in an internal combustion engine of a vehicle, the gas sensor having a sensor cell provided with an exhaust gas electrode exposed to an exhaust gas, an atmosphere side electrode exposed to an atmospheric air and a solid electrolyte interposed therebetween on which the exhaust gas electrode and the atmosphere side electrode are disposed facing each other, and a heater that heats the sensor cell,
the sensor control unit comprising:
a voltage application unit that applies DC voltage between the exhaust gas electrode and the atmosphere side electrode; and
a deterioration detecting unit that detects, during a combustion operation or a combustion stop period of the internal combustion engine, a deterioration quantity of a detection value of the sensor cell,
wherein
the voltage application unit is configured to apply an operation voltage between the exhaust gas electrode and the atmosphere side electrode during the combustion operation, and apply a stop voltage higher than the operation voltage between the exhaust gas electrode and the atmosphere side electrode during the combustion stop period under a condition where the deterioration quantity detected by the deterioration detecting unit is larger than or equal to a predetermined value, thereby reducing silicon oxide adhered to the atmosphere side electrode.
